(19) United States
(12) Patent Application Publication
(10) Pub. No.: US 2022/0132722 A1
(43) Pub. Date: May 5, 2022

(54) TOPOGRAPHIC CONFIDENCE AND CONTROL

(71) Applicant: Deere & Company, Moline, IL (US)

(72) Inventors: Duane M. BOMLENY, Geneseo, IL (US); Nathan R. VANDIKE, Geneseo, IL (US); Noel W. ANDERSON, Fargo, ND (US)

(21) Appl. No.: 17/086,756

(22) Filed: Nov. 2, 2020

(51) Int. Cl. A01B 79/00; B60W 10/04; B60W 10/20; B60W 10/30; G05D 1/02

(52) U.S. Cl. CPC A01B 79/005; G05D 2201/0201; B60W 10/20; B60W 10/30; G05D 1/0219; G05D 1/0223; G05D 1/0278; B60W 2300/15; B60W 2420/42; B60W 2555/00; B60W 2556/10; B60W 2710/09; B60W 2710/20; B60W 2710/305; B60W 2720/10; B60W 10/04

(57) ABSTRACT

A mobile agricultural machine receives a topographic map indicative of topographic characteristics of a worksite, wherein the topographic characteristics are based on data collected at or prior to a first time and receiving supplemental data indicative of characteristics relative to the worksite, the supplemental data collected after the first time. A topographic confidence output is generated which is indicative of a confidence level in the topographic characteristics of the worksite as indicated by the topographic map, based on the topographic map and the supplemental data. In some examples, an action signal is generated to control an action based on the topographic confidence output.

### FIELD OF THE DESCRIPTION

The present description generally relates to the use of a wide variety of different mobile work machines in a variety of operations. More specifically, the present description relates to the use of computing systems in improving control and performance of the various different work machines in the various operations.

### BACKGROUND

There is a wide variety of different types of machines, such as agricultural machines, forestry machines, and construction machines. These types of machines are often operated by an operator and have sensors that generate information during operation. Additionally, the operators of these types of machines can rely on various terrain data relative to a worksite for the control and operation of the various types of machines, for example, a topographic map of the worksite.

Agricultural machines can include a wide variety of machines such as harvesters, sprayers, planters, cultivators, among others. Agricultural machines can be operated by an operator and have many different mechanisms that are controlled by the operator. The machines may have multiple different mechanical, electrical, hydraulic, pneumatic, electromechanical (and other) subsystems, some or all of which can be controlled, at least to some extent, by the operator. Some or all of these subsystems may communicate information that is obtained from sensors on the machine (and from other inputs). Additionally, the operator may rely on the information communicated by the subsystems as well as various types of other information (such as terrain data) for the control of the various subsystems. For example, an operator may rely on topographic information (such as a topographic map of a field) for setting the height (such as from a surface of the field) of various subsystems.

The accuracy and freshness of the information provided to the operator can be important to ensure that the operational parameters of the machines are set to desired levels. Current systems can experience difficulty in providing accurate and fresh information to the operator for the purpose of controlling machines settings.

The discussion above is merely provided for general background information and is not intended to be used as an aid in determining the scope of the claimed subject matter.

### SUMMARY

A mobile agricultural machine receives a topographic map indicative of topographic characteristics of a worksite, wherein the topographic characteristics are based on data collected at or prior to a first time and receiving supplemental data indicative of characteristics relative to the worksite, the supplemental data collected after the first time. A topographic confidence output is generated which is indicative of a confidence level in the topographic characteristics of the worksite as indicated by the topographic map, based on the topographic map and the supplemental data. In some examples, an action signal is generated to control an action based on the topographic confidence output.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial schematic illustration showing one example of a mobile agricultural machine.

FIG. 2 is a perspective view showing one example of a mobile agricultural machine.

FIG. 3 is a block diagram of one example of a computing system architecture that includes the mobile agricultural machines illustrated in FIGS. 1-2.

FIG. 4 is a block diagram of one example of a topographic confidence system, in more detail.

FIG. 5 is a flow diagram showing example operations of the topographic confidence system illustrated in FIG. 4.

FIGS. 6-11 are pictorial illustrations showing example maps that can be generated by the topographic confidence system illustrated in FIG. 4.

FIG. 12 is a block diagram showing one example of the architecture illustrated in FIG. 3 deployed in a remote server architecture.

FIG. 13-15 show examples of mobile devices that can be used in the architecture(s) shown in the previous figure(s).

FIG. 16 is a block diagram showing one example of a computing environment that can be used in the architecture(s) shown in the previous figure(s).

### DETAILED DESCRIPTION

In current agricultural systems, the autonomous controls and human operators of various agricultural machines can rely on topographic maps of the worksite (e.g., field) upon which they operate for the purpose of controlling machine settings and various other operating parameters. For example, the operators can control the height of a combine harvester's header from the surface of the field, the height of a sprayer's boom from the surface of the field, the application of sprayed substance to the surface of the field, among other things.

A survey (such as an aerial survey) of the field can be conducted from which a topographic map can be generated. While these maps can be made with accuracy down to at least several centimeters at the time the data is collected, in the passage of time between conducting the survey and the operation of the agricultural machine on the field, events (e.g., weather events, fires, waves/tides, volcanoes, earthquakes, flooding, human caused events, etc.) can occur that can dynamically alter the topography of the field (as well as other characteristics of the field). For example, but not by limitation, washouts, ruts, drifts, rills, gullies, erosion, material/sediment deposit or build-up (e.g., ridges, soil drift, etc.), among various other conditions, can be present on the field due to the events that occur in the passage of time between conducting the survey and the operation of the agricultural machine on the field. These changes in the topography of the field will not be represented in the topographic map provided to the operator (or the control system) of the agricultural machine. Thus, the machine settings and other operating parameters commanded by the operator (or the control system) can lead to error or other deviation in the performance of the agricultural machines.

The agricultural machine can have on-board sensors which can provide near real-time information indicative of the topography of the field. However, these sensors often have a limited field of view and thus they may not capture and feed information back to the operator (or control system) quickly enough to adjust the machine settings or operating parameters of the agricultural machines to avoid the error or deviation in performance.

Some systems can even utilize perception systems (such as imaging systems mounted on the agricultural machines) or additional survey systems that work in concert with the agricultural machines (such as drones that fly ahead of the agricultural machines). However, these systems may not observe the changes that can occur to the field in a timely or reliable way. For example, vegetation growth on the field may obscure the view of such systems. Further, additional surveys can be performed at a time closer to the time when the operation (e.g., harvesting operation, spraying operation, etc.) is to be performed to, for instance, correct or otherwise supplement the original (e.g., baseline) topographic map. However, and particularly with certain operations, the characteristics of the worksite can be such that additional surveys may not be able to accurately ascertain exact topographic information. For example, at or close to the time that the operation is to be performed, the vegetation on the field can be quite dense and tall, and thus the ability of the sensors on the survey machines to collect topographic data can be diminished or otherwise impeded, as a view of the surface of the field can often be inconsistently visible if not completely obscured. Thus, the topographic information of the particular field may be incomplete or will not otherwise accurately reflect a current topography of the field, and thus, the control of the machine can be sub-optimal.

For instance, the height or tilt of a header on a harvesting machine can be controlled based on a topographic map of the field. The topographic map, however, may not show a new ridge of soil that was created on the field (e.g., by wind or water) in a time after the data for the topographic map was collected. Thus, the header's position (e.g., height, orientation, tilt, etc.) can be such that it will run into the new ridge of soil. In another example, the position (e.g., height, orientation, tilt, etc.) of a boom on a spraying machine can be controlled based on a topographic map of the field. The topographic map, however, may not show a washout that was created on the field (e.g., by water, such as flooding or heavy rain) in a time after the data for the topographic map was collected. Thus, as the spraying machine travels over the field, it can encounter and enter the washout which can lower the height of the boom such that it is no longer traveling above the crop canopy, but is instead traveling through the crops, which can affect the quality of the spraying operation and the effectiveness of the application of sprayed substance. These are merely some examples.

To address at least some of these difficulties, the present description provides a control system including, among other things, a topographic confidence system. As will be discussed further below, the control system obtains (e.g., as a baseline) a topographic map of a field to be operated upon. The control system further obtains supplemental data relative to the field that is gathered in the time between the data for the baseline topographic map was collected and the operation to be performed on the field (or before the operation is performed at a particular geographic location on the field). The control system performs a confidence analysis on the baseline topographic map, based on the supplemental data as well as various algorithmic processes, and generates a topographic confidence output, such as a topographic confidence level or a topographic confidence map of the field indicative of, among other things, a confidence in topographic characteristics of the field as indicated by the baseline map. The system uses the topographic confidence output to generate various action signals. The action signals can be used to automatically or semi-automatically control the machine to improve overall performance by, for example, automatically controlling machine subsystems, providing operator assistance features, and providing indications on interfaces or interface mechanisms that represent various information, including, but not limited to, the topographic confidence output, such as the topographic confidence level or the topographic confidence map of the field.

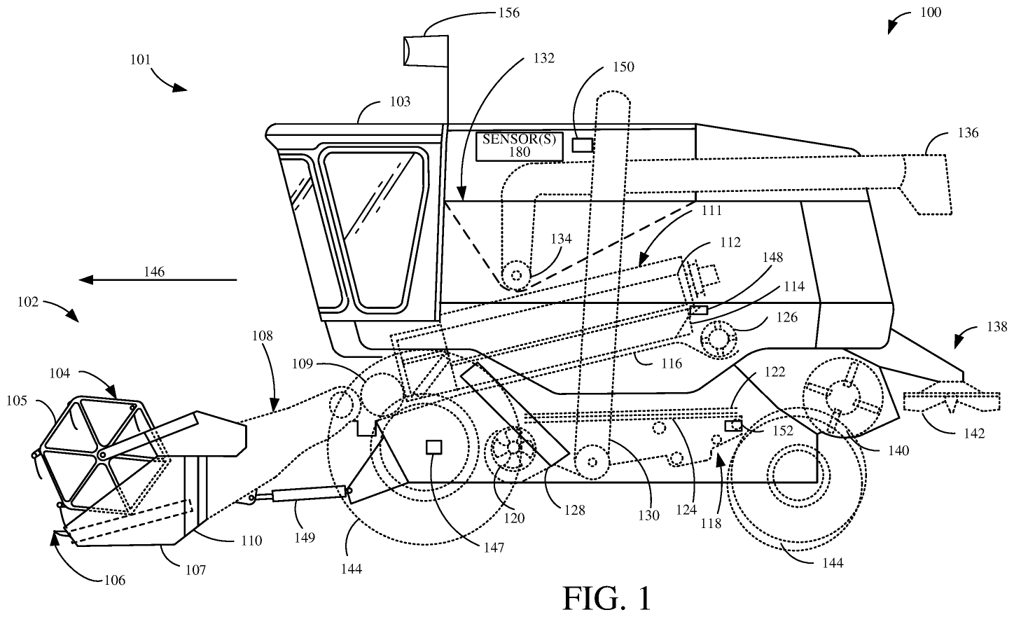

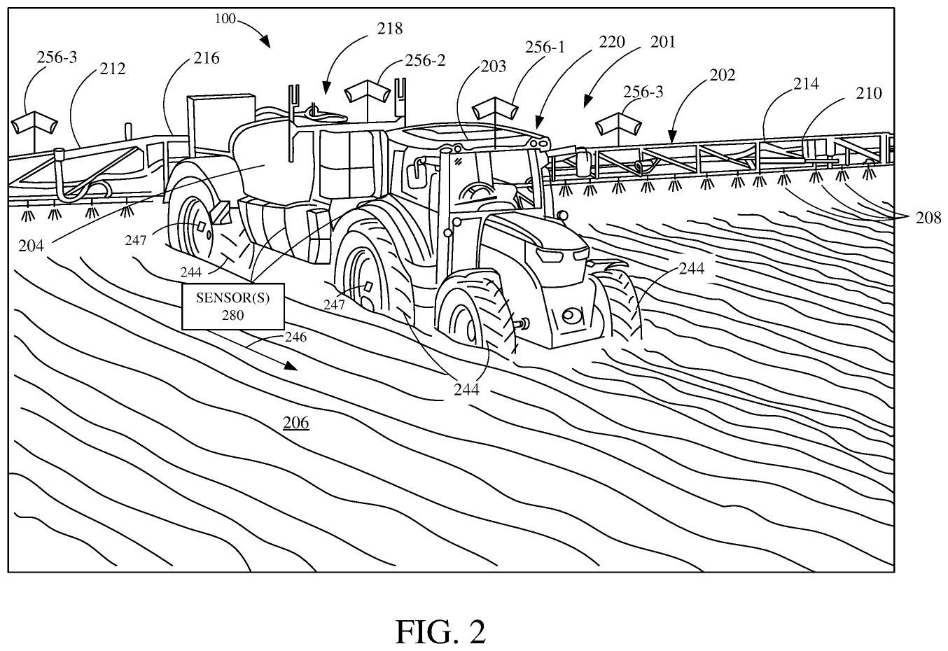

The present description can apply to any of a wide variety of mobile agricultural machines 100. Two are described herein as examples only. FIG. 1 illustrates a harvester 101 and FIG. 2 illustrates a sprayer 201. Again, these are only examples of the different types of mobile agricultural machines that the present description contemplates.

FIG. 1 is a partial pictorial, partial schematic, illustration of a mobile agricultural machine 100, in an example where mobile machine 100 is a combine harvester (also referred to as combine 101 or mobile machine 101). It can be seen in FIG. 1 that combine 101 illustratively includes an operator compartment 103, which can have a variety of different operator interface mechanisms for controlling combine 101. Operator compartment 103 can include one or more operator interface mechanisms that allow an operator to control and manipulate combine 101. The operator interface mechanisms in operator compartment 103 can be any of a wide variety of different types of mechanisms. For instance, they can include one or more input mechanisms such as steering wheels, levers, joysticks, buttons, pedals, switches, etc. In addition, operator compartment 103 may include one or more operator interface display devices, such as monitors, or mobile devices that are supported within operator compartment 103. In that case, the operator interface mechanisms can also include one or more user actuatable elements displayed on the display devices, such as icons, links, buttons, etc. The operator interface mechanisms can include one or more microphones where speech recognition is provided on combine 101. They can also include one or more audio interface mechanisms (such as speakers), one or more haptic interface mechanisms or a wide variety of other operator interface mechanisms. The operator interface mechanisms can include other output mechanisms as well, such as dials, gauges, meter outputs, lights, audible or visual alerts or haptic outputs, etc.

Combine 101 includes a set of front-end machines forming a cutting platform 102 that includes a header 104 having a cutter generally indicated at 106. It can also include a feeder house 108, a feed accelerator 109, and a thresher generally indicated at 111. Thresher 111 illustratively includes a threshing rotor 112 and a set of concaves 114. Further, combine 101 can include a separator 116 that includes a separator rotor. Combine 101 can include a cleaning subsystem (or cleaning shoe) 118 that, itself, can include a cleaning fan 120, a chaffer 122 and a sieve 124. The material handling subsystem in combine 101 can include (in addition to a feeder house 108 and feed accelerator 109) discharge beater 126, tailings elevator 128, clean grain elevator 130 (that moves clean grain into clean grain tank 132) as well as unloading auger 134 and spout 136. Combine 101 can further include a residue subsystem 138 that can include chopper 140 and spreader 142. Combine 101 can also have a propulsion subsystem that includes an engine (or other power source) that drives ground engaging elements 144 (such as wheels, tracks, etc.). It will be noted that combine 101 can also have more than one of any of the subsystems mentioned above (such as left and right cleaning shoes, separators, etc.).

As shown in FIG. 1, header 104 has a main frame 107 and an attachment frame 110. Header 104 is attached to feeder house 108 by an attachment mechanism on attachment frame 110 that cooperates with an attachment mechanism on feeder house 108. Main frame 107 supports cutter 106 and reel 105 and is movable relative to attachment frame 110, such as by an actuator (not shown). Additionally, attachment frame 110 is movable, by operation of actuator 149, to controllably adjust the position of front-end assembly 102 relative to the surface (e.g., field) over which combine 101 travels in the direction indicated by arrow 146, and thus controllably adjust a position of header 104 from the surface. In one example, main frame 107 and attachment frame 110 can be raised and lowered together to set a height of cutter 106 above the surface over which combine 101 is traveling. In another example, main frame 107 can be tilted relative to attachment frame 110 to adjust a tilt angle with which cutter 106 engages the crop on the surface. Also, in one example, main frame 107 can be rotated or otherwise moveable relative to attachment frame 110 to improve ground following performance. In this way, the roll, pitch, and/or yaw of the header relative to the agricultural surface can be controllably adjusted. The movement of main frame 107 together with attachment frame 110 can be driven by actuators (such as hydraulic, pneumatic, mechanical, electromechanical, or electrical actuators, as well as various other actuators) based on operator inputs or automated inputs.

In operation, and by way of overview, the height of header 104 is set and combine 101 illustratively moves over a field in the direction indicated by arrow 146. As it moves, header 104 engages the crop to be harvested and gather it towards cutter 106. After it is cut, the crop can be engaged by reel 105 that moves the crop to a feeding system. The feeding system move the crop to the center of header 104 and then through a center feeding system in feeder house 108 toward feed accelerator 109, which accelerates the crop into thresher 111. The crop is then threshed by rotor 112 rotating the crop against concaves 114. The threshed crop is moved by a separator rotor in separator 116 where some of the residue is moved by discharge beater 126 toward a residue subsystem. It can be chopped by a residue chopper 140 and spread on the field by spreader 142. In other implementations, the residue is simply dropped in a windrow, instead of being chopped and spread.

Grain falls to cleaning shoe (or cleaning subsystem) 118. Chaffer 122 separates some of the larger material from the grain, and sieve 124 separates some of the finer material from the clean grain. Clean grain falls to an auger in clean grain elevator 130, which moves the clean grain upward and deposits it in clean grain tank 132. Residue can be removed from the cleaning shoe 118 by airflow generated by cleaning fan 120. That residue can also be moved rearwardly in combine 100 toward the residue handling subsystem 138.

Tailings can be moved by tailing elevator 128 back to thresher 110 where they can be re-threshed. Alternatively, the tailings can also be passed to a separate re-threshing mechanism (also using a tailings elevator or another transport mechanism) where they can re-threshed as well.

FIG. 1 also shows that, in one example, combine 101 can include a variety of one or more sensors 180, some of which are illustratively shown. For example, combine 100 can include ground speed sensors 147, one or more separator loss sensors 148, a clean grain camera 150, one or more cleaning shoe loss sensors 152, and one or more perception systems 156 (e.g., an imaging system such as a camera). Ground speed sensor 147 illustratively senses the travel speed of combine 100 over the ground. This can be done by sensing the speed of rotation of ground engaging elements 144, the drive shaft, the axle, or various other components. The travel speed can also be sensed by a positioning system, such as a global positioning system (GPS), a dead-reckoning system, a LORAN system, or a wide variety of other systems or sensors that provide an indication of travel speed. Perception system 156 is mounted to and illustratively senses the field (and characteristics thereof) in front of and/or around (e.g., to the sides, behind, etc.) combine 101 (relative to direction of travel 146) and generates sensor signal(s) (e.g., an image) indicative of those characteristics. For example, perception system 156 can generate a sensor signal indicative of change in topography in the field ahead of and/or around combine 101. While shown in a specific location in FIG. 1, it will be noted that perception system 156 can be mounted to various locations on combine 101 and is not limited to the depiction shown in FIG. 1. Additionally, while only one perception system 156 is illustrated, it will be noted that combine 101 can include any number of perception systems 156, mounted to any number of locations within combine 101.

Cleaning shoe loss sensors 152 illustratively provide an output signal indicative of the quantity of grain loss by both the right and left sides of the cleaning shoe 118. In one example, sensors 152 are strike sensors which count grain strikes per unit of time (or per unit of distance traveled) to provide an indication of the cleaning shoe grain loss. The strike sensors for the right and left sides of the cleaning shoe can provide individual signals, or a combined or aggregated signal. It will be noted that sensors 152 can comprise on a single sensor as well, instead of separate sensors for each shoe.

Separator loss sensors 148 provide signals indicative of grain loss in the left and right separators. The sensors associated with the left and right separators can provide separate grain loss signals or a combined or aggregate signal. This can be done using a wide variety of different types of sensors as well. It will be noted that separator loss sensors 148 may also comprise only a single sensor, instead of separate left and right sensors.

It will be appreciated, and as will be discussed further herein, sensors 180 can include a variety of other sensors not illustratively shown in FIG. 1. For instance, they can include residue setting sensors that are configured to sense whether combine 100 is configured to chop the residue, drop a windrow, etc. They can include cleaning shoe fan speed sensors that can be configured proximate fan 120 to sense the speed of the fan. They can include threshing clearance sensors that sense clearance between the rotor 112 and concaves 114. They can include threshing rotor speed sensors that sense a rotor speed of rotor 112. They can include chaffer clearance sensors that sense the size of openings in chaffer 122. They can include sieve clearance sensors that sense the size of openings in sieve 124. They can include material other than grain (MOG) moisture sensors that can be configured to sense the moisture level of the material other than grain that is passing through combine 101. They can include machine settings sensors that are configured to sense the various configured settings on combine 101. They can also include machine orientation sensors that can be any of a wide variety of different types of sensors that sense the orientation of combine 101, and/or components thereof. They can include crop property sensors that can sense a variety of different types of crop properties, such as crop type, crop moisture, and other crop properties. The crop property sensors can also be configured to sense characteristics of the crop as they are being processed by combine 101. For instance, they can sense grain feed rate, as it travels through clean grain elevator 120. They can sense mass flow rate of grain through elevator 130 or provide other output signals indicative of other sensed variables. Sensors 180 can include soil property sensors that can sense a variety of different types of soil properties, including, but not limited to, soil type, soil compaction, soil moisture, soil structure, among others.

Some additional examples of the types of sensors that can be used are described below, including. but not limited to a variety of position sensors that can generate sensor signals indicative of a position of combine 101 on the field over which combine 101 travels or a position of various components of combine 101 (e.g., header 104) relative to, for example, the field over which combine 101 travels.

As combine 101 moves in the direction indicated by arrow 146, it may be that the ground under, ahead, or otherwise around combine 101 contains obstacles or variations in topography. In operation, the operator sets the position of header 104 to a certain height from the field such that header 104 effectively engages the crop. Obstacles and/or variations in the topography of the field can cause a change in the distance of header 104 from the field and can thus cause header 104 to engage the crop improperly or otherwise undesirably. Such errors can affect, amongst other things, the crop yield produced by combine 101. Additionally, sudden changes in the topography of the field or encountering obstacles can cause header 104 to collide with the field.

FIG. 2 is a perspective showing one example of a mobile agricultural machine, in an example where mobile machine 100 is an agricultural sprayer (also referred to as sprayer 201 or mobile machine 201). It can be seen in FIG. 1 that agricultural sprayer 201 includes a spraying system 202 having a tank 204 containing a liquid that is to be applied to field 206 as agricultural sprayer travels in the direction indicated by arrow 246. Tank 204 is fluidically coupled to spray nozzles 208 by a delivery system comprising a set of conduits that define a flow path for the liquid from tank 204 to one or more spray nozzles 208. A fluid conveyance system (e.g., a fluid pump) is configured to convey the liquid from tank 204 through the conduits to and through nozzles 208. The operation of the fluid conveyance system is adjustable, such as automatically or manually, to vary a pressure, a flow rate of liquid, as well as various other fluid characteristics of spraying system 202. Spray nozzles 208 are coupled to and spaced apart along boom 210. In one example, the operation and position of spray nozzles 208 can be adjusted, such as automatically or manually. For example, the position (e.g., height, orientation, tilt, etc.) of nozzles 208 can be adjusted, as well as the volume or flow rate of liquid passing through nozzles 208 (such as by operation of a controllable valve). Boom 210 includes arms 212 and 214 which can articulate or pivot relative to a center frame 216. Thus, arms 212 and 214 are movable between a storage or transport position and an extended or deployed position (shown in FIG. 2). The position (e.g., height, orientation, tilt, etc.) of boom 210 and/or arms 212 and 214 can be adjustable by actuation or operation of a controllable actuator (not shown) to drive movement of the boom 210 and/or arms 212 and 214. For example, but not by limitation, the distance (e.g., height) of boom 210 and/or arms 212 and 214 from field 206 can be varied, such as automatically or manually.

In the example illustrated in FIG. 2, sprayer 201 comprises a towed implement 218 that carries spraying system 202, and is towed by a towing or support machine 220 (illustratively a tractor) having an operator compartment 203, which can have a variety of different operator interface mechanisms for controlling sprayer 201. Operator compartment 203 can include one or more operator interface mechanisms that allow an operator to control and manipulate sprayer 201. The operator interface mechanisms in operator compartment 203 can be any of a wide variety of different types of mechanisms. For instance, they can include one or more input mechanisms such as steering wheels, levers, joysticks, buttons, pedals, switches, etc. In addition, operator compartment 203 may include one or more operator interface display devices, such as monitors, or mobile devices that are supported within operator compartment 203. In that case, the operator interface mechanisms can also include one or more user actuatable elements displayed on the display devices, such as icons, links, buttons, etc. The operator interface mechanisms can include one or more microphones where speech recognition is provided on sprayer 201. They can also include audio interface mechanisms (such as speakers), one or more haptic interface mechanisms or a wide variety of other operator interface mechanisms. The operator interface mechanisms can include other output mechanisms as well, such as dials, gauges, meter outputs, lights, audible or visual alerts or haptic outputs, etc.

Sprayer 201 includes a set of ground engaging elements 244, such as wheels, tracks, etc. Sprayer 201 can also have a propulsion subsystem that includes an engine (or other power source) that drives ground engaging elements 244. It will be noted that in other examples, sprayer 201 is self-propelled. That is, rather than being towed by a towing machine, the machine that carries the spraying system also includes propulsion and steering systems.

In operation, and by way of overview, the height of boom 210 (or arms 212 and 214) are set and sprayer 201 moves over field 206 in the direction indicated by arrow 246. As it moves, liquid is conveyed from tank 204 through conduits in boom 210 and to and through nozzles 208 to be applied to vegetation on field 206. The application of liquid on field 206 can be controllably adjusted. For example, but not by limitation, by varying the height of boom 210 (or arms 212 and 214) off of field 206, varying the position (e.g., height, orientation, tilt, etc.) of nozzles 208, varying the flow characteristics of the liquid through the spraying system, etc.

FIG. 2 also shows that, in one example, sprayer 201 can include a variety of one or more sensors 280, some of which are illustratively shown. For example, sprayer 201 can include one or more ground speed sensors 247, and one or more perception systems 256 (e.g., an imaging system such as a camera). Ground speed sensors 247 illustratively sense the travel speed of sprayer 201 over field 206. This can be done by sensing the speed of rotation of ground engaging elements 244, the drive shaft, the axle, or various other components. The travel speed can also be sensed by a positioning system, such as a global positioning system (GPS), a dead-reckoning system, a LORAN system, or a wide variety of other systems or sensors that provide an indication of travel speed. Perception systems 256 (identified as 256-1 to 256-3) are mounted at various locations within sprayer 201 and illustratively sense the field (and characteristics thereof) in front of or around (e.g., to the sides, behind, etc.) sprayer 201 (relative to direction of travel 246) and generate sensor signal(s) (e.g., images) indicative of those characteristics. For example, forward-looking perception systems 256 can generate sensor signals indicative of change in topography field 206 ahead of or around sprayer 201. While shown in specific location in FIG. 2, it will be noted that perception systems 256 can be mounted at various locations within sprayer 201 and are not limited to the depiction shown in FIG. 2.

Additionally, while a particular number of perception systems 256 are shown in the illustration, it will be noted that any number of perception systems can be placed at any number of locations within sprayer 201. FIG. 2 shows that the perception systems 256 can be mounted at one or more locations within sprayer 201. For example, they can be mounted on towing vehicle 220, as indicated by perception systems 256-1. They can be mounted on implement 218, as indicated by perception systems 256-2. They can be mounted on and spaced apart along boom 210, including each of boom arms 212 and 214, as indicated by perception systems 256-3. Perception systems 256 can be forward-looking systems configured to look ahead of components of sprayer 201, side-looking systems configured to look to the sides of components of sprayer 201, or rearward-looking systems configured to look behind components of sprayer 201. Perception systems 256 can be mounted on sprayer 201 such that they travel above or below a canopy of vegetation on agricultural surface 206. It is noted that these are only some examples of locations of perception systems 256, and that perception systems 256 can be mounted at one or more of these locations or various other locations within sprayer 201 or any combinations thereof.

It will be appreciated, and as will be discussed further herein, sensors 280 can include a variety of other sensors not illustratively shown in FIG. 2. For instance, they can include machine settings sensors that are configured to sense the various configured settings on sprayer 201. Sensors 280 can also include machine orientation sensors that can be any of a wide variety of different types of sensors that sense the orientation of sprayer 201, or the orientation of components of sprayer 201. Sensors 208 can include crop property sensors that can sense a variety of different types of crop properties, such as crop type, crop moisture, and other crop properties. Sensors 208 can include soil property sensors that can sense a variety of different types of soil properties, including, but not limited to, soil type, soil compaction, soil moisture, soil structure, among others.

Some additional examples of the types of sensors that can be used are described below, including. but not limited to a variety of position sensors that can generate sensor signals indicative of a position of sprayer 201 on the field over which sprayer 201 travels or a position of various components of sprayer 201 (e.g., nozzles 208, boom 210, arms 212 and 214, etc.) relative to, for example, the field over which sprayer 201 travels.

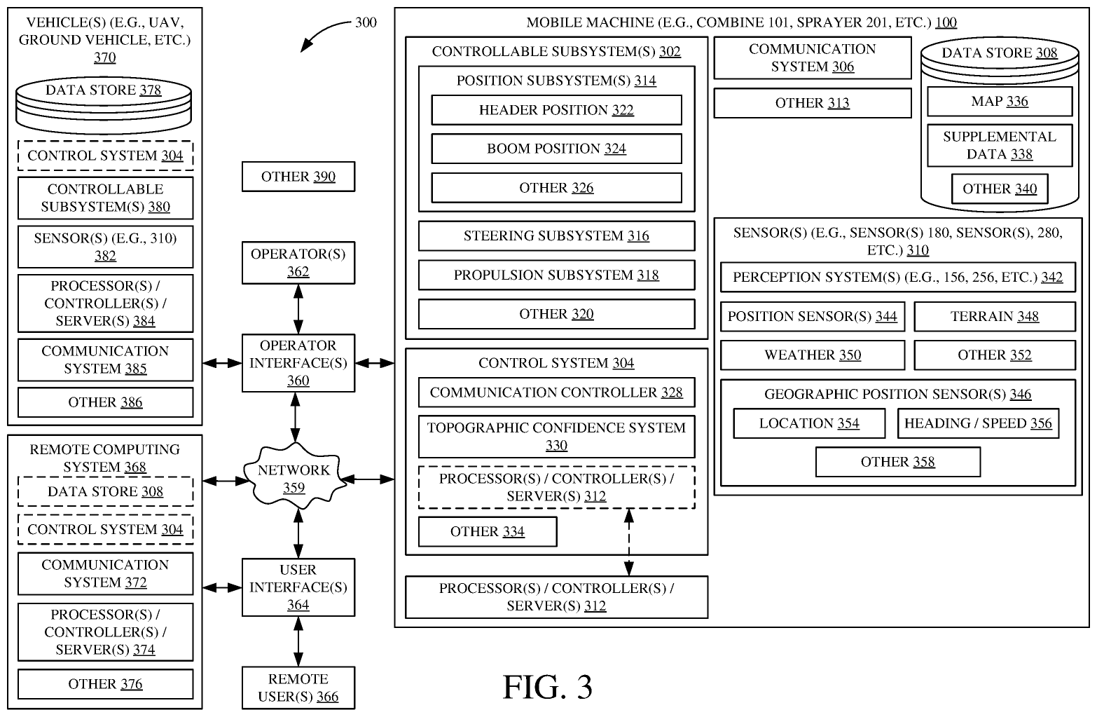

FIG. 3 is a block diagram of one example of a computing architecture 300 having, among other things, a mobile machine 100 (e.g., combine 101, sprayer 201, etc.) configured to perform an operation (e.g., harvesting, spraying, etc.) at a worksite (such as field 206). Some items are similar to those shown in FIGS. 1-2 and they are similarly numbered. FIG. 3 shows that architecture 300 includes mobile machine 100, network 359, one or more operator interfaces 360, one or more operators 362, one or more user interfaces 364, one or more remote users 366, one or more remote computing systems 368, one or more vehicles 370, and can include other items 390 as well. Mobile machine 100 can include one or more controllable subsystems 302, control system 304, communication system 306, one or more data stores 308, one or more sensors 310, one or more processors, controllers, or servers 312, and it can include other items 313 as well. Controllable subsystems 302 can include position subsystem(s) 314, steering subsystem 316, propulsion subsystem 318, and can include other items 320 as well, such as other subsystems, including, but not limited to those described above with reference to FIGS. 1-2. Position subsystem(s) 314, itself, can include header position subsystem 322, boom position subsystem 324, and it can include other items 326.

Control system 304 can include one or more processors, controllers, or servers 312, communication controller 328, topographic confidence system 330, and can include other items 334. Data stores 308 can include map data 336, supplemental data 338, and can include other data 340.

FIG. 3 also shows that sensors 310 can include any number of different types of sensors that sense or otherwise detect any number of characteristics. Such as, characteristics relative to the environment of mobile machine 100 (e.g., agricultural surface 206), as well as the environment of other components in computing architecture 300. Further, sensors 310 can sense or otherwise detect characteristics relative to the components in computing architecture 300, such as operating characteristics of mobile machine 100 or vehicles 370, such as, current positional information relative to the header of combine 101 or the boom of sprayer 201. In the illustrated example, sensors 310 can include one or more perception systems 342 (such as 156 and/or 256 described above), one or more position sensors 344, one or more geographic position sensors 346, one or more terrain sensors 348, one or more weather sensors 350, and can include other sensors 352 as well, such as, any of the sensors described above with reference to FIGS. 1-2 (e.g., sensors 180 or 280). Geographic position sensor 346, itself, can include one or more location sensors 354, one or more heading/speed sensors 356, and can include other items 358.

Control system 304 is configured to control other components and systems of computing architecture 300, such as components and systems of mobile machine 100 or vehicles 370. For instance, communication controller 328 is configured to control communication system 306. Communication system 306 is used to communicate between components of mobile machine 100 or with other systems such as vehicles 370 or remote computing systems 368 over network 359. Network 359 can be any of a wide variety of different types of networks such as the Internet, a cellular network, a wide area network (WAN), a local area network (LAN), a controller area network (CAN), a near-field communication network, or any of a wide variety of other networks or combinations of networks or communication systems.

Remote users 366 are shown interacting with remote computing systems 368, such as through user interfaces 364. Remote computing systems 368 can be a wide variety of different types of systems. For example, remote computing systems 368 can be in a remote server environment. Further, it can be a remote computing system (such as a mobile device), a remote network, a farm manager system, a vendor system, or a wide variety of other remote systems. Remote computing systems 368 can include one or more processors, controllers, or servers 374, a communication system 372, and it can include other items 376. As shown in the illustrated example, remote computing system 368 can also include one or more data stores 308 and control system 304. For example, the data stored and accessed by various components in computing architecture 300 can be remotely located in data stores 308 on remote computing systems 368. Additionally, various components of computing architecture 300 (e.g., controllable subsystems 202) can be controlled by a control system 304 located remotely at a remote computing system 368. Thus, in one example, a remote user 366 can control mobile machine 100 or vehicles 370 remotely, such as by a user input received by user interfaces 364. These are merely some examples of the operation of computing architecture 300.

Vehicles 370 (e.g., UAV, ground vehicle, etc.) can include one or more data stores 378, one or more controllable subsystems 380, one or more sensors 382, one or more processors, controllers, or servers 384, a communication system 385, and it can include other items 386. In the illustrated example, vehicles 370 can also include control system 304. Vehicles 370 can be used in the performance of an operation at a worksite, such as a spraying or harvesting operation on an agricultural surface. For instance, a UAV or ground vehicle 370 can be controlled to travel over the worksite, including ahead of or behind mobile machine 100. Sensors 382 can include any number of a wide variety of sensors, such as, sensors 310. For example, sensors 382 can include perception systems 342. In a particular example, vehicles 370 can travel the field ahead of mobile machine 100 and detect any number of characteristics that can be used in the control of mobile machine 100, such as, detecting topographic characteristics ahead of combine 101 or sprayer 201 to control a height of header 102 or boom 110, from a surface of the worksite (e.g., field 206) as well as various other operating parameters of various other components. In another example, vehicles 370 can travel the field behind mobile machine 100 and detect any number of characteristics that can be used in the control of mobile machine 100, sot that, vehicles 370 can enable closed-loop control of mobile machine 100. In another example, vehicles 370 can be used to perform a scouting operation to collect additional data, such as topographic data, relative to the worksite or particular geographic locations of the worksite.

Additionally, control system 304 can be located on vehicles 370 such that vehicles 370 can generate action signals to control an action of mobile machine 100 (e.g., adjusting an operating parameter of one or more controllable subsystems 302), based on characteristics sensed by sensors 382. Further, a confidence map can be generated by control system 304 on vehicles 370 to be used for the control of mobile machine 100.

As illustrated, vehicles 370 can include a communication system 385 configured to communicate with other components of computing architecture 300, such as mobile machine 100 or remote computing systems 368, as well as between components of vehicles 370.

FIG. 3 also shows one or more operators 362 interacting with mobile machine 100, remote computing systems 368, and vehicles 370, such as through operator interfaces 360. Operator interfaces 360 can be located on mobile machine 100 or vehicles 370, for example in an operator compartment (e.g., 103 or 203, etc.), such as a cab, or they can be another operator interface communicably coupled to various components in computing architecture 300, such as a mobile device or other interface mechanism.

Before discussing the overall operation of mobile machine 100, a brief description of some of the items in mobile machine 100, and their operation, will first be provided.

Communication system 306 can include wireless communication logic, which can be substantially any wireless communication system that can be used by the systems and components of mobile machine 100 to communicate information to other items, such as among control system 304, data stores 308, sensors 310, controllable subsystems 302, and topographic confidence system 330. In another example, communication system 306 communicates over a controller area network (CAN) bus (or another network, such as an Ethernet network, etc.) to communicate information between those items. This information can include the various sensor signals and output signals generated by the sensor characteristics and/or sensed characteristics, and other items.

Perception systems 342 are configured to sense various characteristics relative to the environment around mobile machine 100, such as characteristics relative to the worksite surface. For example, perception system(s) 342 can be configured to sense characteristics relative to the vegetation on the worksite surface (e.g., stage, stress, damage, knockdown, density, height, Leaf Area index, etc.), characteristics relative to the topography of the worksite surface (e.g., washouts, ruts, drifts, soil erosion, soil deposits, soil buildup, obstacles, etc.), characteristics relative to the soil (e.g., type, compaction, structure, etc.), characteristics relative to soil cover (e.g., residue, cover crop, etc.), as well as various other characteristics. Perception system(s) 342 can also sense topographic characteristics of the worksite surface ahead of mobile machine 100, such that a change in topography can be determined and the height of header 104 or boom 210 can be adjusted. Perception systems 342 can, in one example, comprise imaging systems, such as cameras.

Position sensors 344 are configured to sense position information relative to various components of agricultural spraying system 102. For example, a number of position sensors 344 can be disposed at various locations within mobile machine 100. They can thus detect a position (e.g., height, orientation, tilt, etc.) of the various components of mobile machine 100, such as the height of header 104 or boom 210 (or boom arms 212 and 214) above agricultural surface 110, the height or orientation of nozzles 208, as well as position information relative to various other components. Position sensors 344 can be configured to sense position information of the various components of mobile machine 100 relative to any number of items, such as position information relative to the worksite surface, position information relative to other components of mobile machine 100, as well as a variety of other items. For instance, position sensors 344 can sense the height of header 104, boom 210 or spray nozzle(s) 208 from a detected top of vegetation on the worksite surface. In another example, the position and orientation of other items can be calculated, based on a sensor signal, by knowing the dimensions of the mobile machine 100.

Geographic position sensors 346 include location sensors 354, heading/speed sensors 356, and can include other sensors 358 as well. Location sensors 354 are configured to determine a geographic location of mobile machine on the worksite surface (e.g., field 206). Location sensors 354 can include, but are not limited to, a Global Navigation Satellite System (GNSS) receiver that receives signals from a GNSS satellite transmitter. Location sensors 354 can also include a Real-Time Kinematic (RTK) component that is configured to enhance the precision of position data derived from the GNSS signal. Location sensors 354 can include various other sensors, including other satellite-based sensors, cellular triangulation sensors, dead reckoning sensors, etc.

Heading/speed sensors 356 are configured to determine a heading and speed at which mobile machine 100 is traversing the worksite during the operation. This can include sensors that sense the movement of ground-engaging elements (e.g., wheels or tracks 144 or 244) or can utilize signals received from other sources, such as location sensors 354.

Terrain sensors 348 are configured to sense characteristics of the worksite surface (e.g., field 206) over which mobile machine 100 is traveling. For instance, terrain sensors 348 can detect the topography of the worksite (which may be downloaded as a topographic map or sensed with sensors) to determine the degree of slope of various areas of the worksite, to detect a boundary of the field, to detect obstacles or other objects on the field (e.g., rocks, root-balls, trees, etc.), among other things.

Weather sensors 350 are configured to sense various weather characteristics relative to the worksite. For example, weather sensors 350 can detect the direction and speed of wind traveling over the worksite. Weather sensors 350 can detect precipitation, humidity, temperature, as well as numerous other conditions. This information can be obtained from a remote weather service as well.

Other sensors 352 can include, for example, operating parameter sensors that are configured to sense characteristics relative to the machine settings or operation of various components of mobile machine 100 or vehicles 370.

Sensors 310 can comprise any number of different types of sensors. Such as potentiometers, Hall Effect sensors, various mechanical and/or electrical sensors. Sensors 310 can also comprise various electromagnetic radiation (ER) sensors, optical sensors, imaging sensors, thermal sensors, LIDAR, RADAR, Sonar, radio frequency sensors, audio sensors, inertial measurement units, accelerometers, pressure sensors, flowmeters, etc. Additionally, while multiple sensors are shown detecting or otherwise sensing respective characteristics, sensors 310 can include a sensor configured to sense or detect a variety of the different characteristics and can produce a single sensor signal indicative of the multiple characteristics. For instance, sensors 310 can comprise an imaging sensor mounted at various locations within mobile machine 100 or vehicles 370. The imaging sensor can generate an image that is indicative of multiple characteristics relative to both mobile machine 100 and vehicles 370 as well as their environment (e.g., agricultural surface 110). Further, while multiple sensors are shown, more or fewer sensors 310 can be utilized.

Additionally, it is to be understood that some or all of the sensors 310 can be a controllable subsystem of mobile machine 100. For example, control system 304 can generate a variety of action signals to control the operation, position (e.g., height, orientation, tilt, etc.), as well as various other operating parameters of sensors 310. For instance, because the vegetation on the worksite can obscure the line of view of perception systems 342, control system 304 can generate action signals to adjust the position or orientation of perception systems 342 to thereby adjust their line of sight. These are examples only. Control system 304 can generate a variety of action signals to control any number of operating parameters of sensor(s) 310.

Controllable subsystems 302 illustratively include position subsystem(s) 314, steering subsystem 316, propulsion subsystem 318, and can include other subsystems 320 as well. The controllable subsystems 302 are now briefly described.

Position subsystem(s) 314 are generally configured to control the position (e.g., height, orientation, tilt, etc.) or otherwise actuate movement of various components of mobile machine 100. Position subsystem(s) 314, itself, can include header position subsystem 322, boom position subsystem 324, and can include other position subsystems 326 as well. Header position subsystem 322 is configured to controllably adjust the position (e.g., height, orientation, tilt, etc.) or otherwise actuate movement of header 104 on combine 101. Header position subsystem 322 can include a number of actuators (such as electrical, hydraulic, pneumatic, mechanical or electromechanical actuators, as well as numerous other types of actuators) that are coupled to various components to adjust a position (e.g., height, orientation, tilt, etc.) of header 104 relative to the worksite surface (e.g., surface of field). For instance, upon the detection of an upcoming shift in topography (e.g., detection of a rut or a soil buildup, an obstacle, etc.) on the worksite surface, action signals can be provided to header position subsystem 322 to adjust the position (e.g., height, orientation, tilt, etc.) of header 104 relative to the worksite surface.

Boom position subsystem 324 is configured to controllably adjust the position (e.g., height, orientation, tilt, etc.) or otherwise actuate movement of boom 210, including individual boom arms 212 and 214. For example, boom position subsystem 324 can include a number of actuators (such as electrical, hydraulic, pneumatic, mechanical or electromechanical actuators, as well as numerous other types of actuators) that are coupled to various components to adjust a position or orientation of boom 210 or individual boom arms 212 and 214. For instance, upon the detection of characteristics relative to the topography of agricultural surface 206 (e.g., detection of a rut, soil buildup, an obstacle, etc. on agricultural surface 206), action signals can be provided to boom position subsystem 324 to adjust the position of boom 210 or boom arms 212 or 214 relative to agricultural surface 206.

Other position subsystems 326 can include a nozzle position subsystem configured to controllably adjust the position (e.g., height, orientation, tilt, etc.) or otherwise actuate movement of nozzles 208. The nozzle position subsystem can include a number of actuators (such as electrical, hydraulic, pneumatic, mechanical or electromechanical actuators, as well as numerous other types of actuators) that are coupled to various components to adjust a position (e.g., height, orientation, tilt, etc.) of nozzles 208. For example, upon the detection of an upcoming shift in topography (e.g., detection of a rut, soil buildup, an obstacle, etc.) or an upcoming shift in the height of vegetation (e.g., height of crop, weeds, etc.) on agricultural surface 206, action signals can be provided to the nozzle position subsystem to adjust the position (e.g., height, orientation, tilt, etc.) of nozzles 208 relative to agricultural surface 206 or relative to vegetation on agricultural surface 206.

Steering subsystem 316 is configured to control the heading of mobile machine 100, by steering the ground engaging elements (e.g., wheels or tracks 144 or 244). Steering subsystem 316 can adjust the heading of mobile machine 100 based on action signals generated by control system 304. For example, based on sensor signals generated by sensors 310 indicative of a change in topography, control system 304 can generate action signals to control steering subsystem 316 to adjust the heading of mobile machine 100. In another example, control system 304 can generate action signals to control steering subsystem 316 to adjust the heading of mobile machine 100 to comply with a commanded route, such as an operator or user commanded route, or, and as will be described in more detail below, a route based on a topographic confidence map generated by topographic confidence system 330, as well as various other commanded routes. The route can also be commanded based upon characteristics of the environment in which mobile machine 100 is operating that are sensed or otherwise detected by sensors 310. Such as characteristics sensed or detected by perception systems 342 on mobile machine 100 or vehicles 370. For example, based on an upcoming shift in the topography, such as a rut, at the worksite, sensed by perception systems 342, a route can be generated by control system 304 to change the heading of mobile machine 100 to avoid the rut.

Propulsion subsystem 318 is configured to propel mobile machine 100 over the worksite surface, such as by driving movement of ground engaging elements (e.g., wheels or tracks 144 or 244). It can include a power source, such as an internal combustion engine or other power source, a set of ground engaging elements, as well as other power train components. In one example, propulsion subsystem 318 can adjust the speed of mobile machine 100 based on action signals generated by control system 304, which can be based upon various characteristics sensed or detected by sensors 310, a topographic confidence map generated by topographic confidence system 330, as well as various other bases, such as operator or user inputs.

Other subsystem(s) 320 can include various other subsystems, such as a substance delivery subsystem on sprayer 202. The substance delivery subsystem can include one or more pumps, one or more substance tanks, flow paths (e.g., conduits), controllable valves (e.g., pulse width modulation valves, solenoid valves, etc.), one or more nozzles (e.g., nozzles 208), as well as various other items. The one or more pumps can be controllably operated to pump substance (e.g., herbicide, pesticide, insecticide, fertilizer, etc.) along a flow path defined by a conduit to nozzles 208 which can be mounted on and spaced along boom 210, as well as mounted at other locations within sprayer 202. In one example, a number of controllable valves can be placed along the flow path (e.g., a controllable valve associated with each of nozzles 208) that can be controlled between an on (e.g., open) and off (e.g., closed) position, to control the flow of substance through the valves (e.g., to control the flow rate).

The substance tanks can comprise multiple hoppers or tanks, each configured to separately contain a substance, which can be controllably and selectively pumped by the one or more pumps through the flow path to spray nozzles 208. The operating parameters of the one or more pumps can be controlled to adjust a pressure or a flow rate of the substance, as well as various other characteristics of the substance to be delivered to the worksite.

Nozzles 208 are configured to apply the substance to the worksite (e.g., field 206) such as by atomizing the substance. Nozzles 208 can be controllably operated, such as by action signals received from control system 304 or manually by an operator 264. For example, nozzles 208 can be controllably operated between on (e.g., open) and off (e.g., closed). Additionally, nozzles 208 can be individually operated to change a characteristic of the spray emitted by nozzles 208, such as a movement (e.g., a rotational movement) of nozzles 208 that widens or narrows the flow path through and out of nozzles 208 to affect the pattern, the volume, as well as various other characteristics, of the spray.

Control system 304 is configured to receive or otherwise obtain various data and other inputs, such as sensor signals, user or operator inputs, data from data stores, and various other types of data or inputs. Based on the data and inputs, control system 304 can make various determinations and generate various action signals.

Control system 304 can include topographic confidence system 330. Topographic confidence system 330 can, based on information accessed within data stores (e.g., 208, 378, etc.) or data received from sensors (e.g., 310, 382, etc.), determine a confidence level in the topographic characteristics of a worksite indicated by a prior topographic map and generate various topographic confidence outputs indicative of the determined topographic confidence level. For example, topographic confidence system 330 can generate topographic confidence outputs as representations indicative of the topographic confidence level for the worksite or for various portions of the worksite. These representations can be numeric, such as percentages (e.g., 0%-100%) or scalar values, gradation or scaled (e.g., A-F, “high, medium, low”, 1-10, etc.), advisory (e.g., caution, proceed, slow, scout first, no crop, etc.), as well as various other representations. Additionally, topographic confidence system 330 can generate, as a topographic confidence output, a topographic confidence map that indicates the topographic confidence level for the worksite or particular portions of the worksite.

The topographic confidence outputs can be used by control system 304 to generate a variety of action signals to control an action of mobile machine 100 as well as other components of computing architecture 300, such as vehicles 370, remote computing systems 368, etc. For example, based on the topographic confidence output, control system 304 can generate an action signal to provide an indication (e.g., alert, display, notification, recommendation, etc.) on a variety of interfaces or interface mechanisms, such operator interfaces 360 or user interfaces 364. The indication can include an audio, visual, or haptic output. In another example, based on the topographic confidence output, control system 304 can generate an action signal to control an action of one or more of the various components of computing architecture 300, such as operating parameters of one or more of controllable subsystems 302 or controllable subsystems 380. For instance, based on the topographic confidence output, control system 304 can generate an action signal to control position subsystem(s) 314 to control a position (e.g., height, orientation, tilt, etc.) of header 104 or boom 210. Control system 304 can also control steering subsystem 316 to control a heading of mobile machine 100, and propulsion subsystem 318 to control a speed of mobile machine 100. Control system 304 can also control various other subsystems, such as substance delivery subsystem to control the delivery of substance to the worksite. These are examples only. Control system 304 can generate any number of action signals based on a topographic confidence output generated by topographic confidence system 330 to control any number of actions of the components in computing architecture 300.

Control system 304 can include various other items 334, such as other controllers. For example, control system 304 can include a dedicated controller corresponding to each one of the various controllable subsystems. Such dedicated controllers may include a spraying subsystem controller, a boom position subsystem controller, a steering subsystem controller, a propulsion subsystem controller, as well as various other controllers for various other controllable subsystems. Additionally, control system 304 can include various logic components, for example, image processing logic. Image processing logic can process images generated by sensors 310 (e.g., images generated by perception systems 342), to extract data from the images. Image processing logic can utilize a variety of image processing techniques or methods, such as RGB, edge detection, black/white analysis, machine learning, neural networks, pixel testing, pixel clustering, shape detection, as well any number of other suitable image processing and data extraction techniques and/or methods.

FIG. 3 also shows that data stores 308 can include map data 336, supplemental data 338, as well as various other data 340. Map data 336 can include one or more topographic maps of a worksite that indicate topographic characteristics (e.g., slope, elevation, etc.) at geographic locations of the worksite. The topographic maps can include georeferenced data represented in various ways, such as geotagged data, rasters, polygons, point clouds, as well in various other ways. The map can be generated based on outputs from sensors, such as imaging sensors (e.g., stereo, lidar, etc.) during a survey or fly-over of the worksite as well from previous passes or operations of a mobile machine on the worksite. These topographic maps may be generated (particularly when based on overhead imaging) on the basis of data that is collected during a bare field condition when the field surface has substantially no obscurity due to vegetation, such as during post-harvest, prior to planting, right after planting, etc. The topographic maps can be used in the control of mobile machine 100 as it travels over the worksite, or, as will be described further below, as a baseline.

Supplemental data 338 can include a variety of data indicative of various characteristics relative to the worksite or relative to the environment of the worksite that is obtained or collected at a time later than the time the data for the prior topographic map was collected. In one example, supplemental data 338 includes any of a variety of data that can indicate a characteristic or condition that can affect the topography of the worksite. This can include data obtained or collected prior to mobile machine 100 operating on the worksite as well as in-situ data (e.g., from sensors 310 or 382). Supplemental data can include weather data (e.g., rain, snow, ice, hail, wind, as well as weather events such as tornadoes, hurricanes, storms, tsunamis, etc.), environmental data (e.g., waves and tides), event data (e.g., fires, volcanoes, floods, earthquakes, etc.), additional topographic data (e.g., generated by sensors on a machine traveling over the worksite such as a survey, fly over, additional operation, etc.), vegetation data (e.g., images of the vegetation, crop type, weed type, density, height, Vegetation Index, vegetation state data, etc.), activity data (e.g., data that indicates that human activity occurred on the worksite, such as operations of other machines, etc.), additional images of the worksite, as well as various other supplemental data. Supplemental data can be obtained from various sources, such as machines doing surveys or flyovers of the worksite, various other sensors, weather stations, news sources, operator or user inputs, as well as a variety of other sources. Supplemental data can also be obtained or collected by and received from sensors mobile machine 100 or sensors on vehicles 370 during operation (e.g., in-situ) or prior to operation.

The supplemental data can be indicative of a variety of characteristics relative to the worksite or the environment of the worksite. Based on the supplemental data, topographic confidence system 330 can determine a confidence in the topographic characteristics of the worksite indicated by a prior topographic map. In one example, topographic confidence system 330 can determine whether a change to the topography of the worksite has occurred or has likely occurred based on the indications provided by the supplemental data. For example, if certain weather conditions have occurred (e.g., certain levels of rainfall) after the data for the prior topographic map was collected, topographic confidence system 330 can determine that the topography at the worksite, or the topography at particular geographic locations within the worksite, has changed or has likely changed. This is merely an example. Topographic confidence system 330 can determine a confidence in the topographic characteristics of the worksite or of particular geographic locations within the worksite based on any number of indications provided by supplemental data, and any combinations thereof. Further, it will be noted that the term likely means, in one example, a threshold likelihood or probability that a current topography characteristic deviates by a threshold amount from characteristics indicated by the prior topographic map. In one example, the threshold can be input by an operator or user or set automatically by topographic confidence system indicating a level of deviation from the characteristics indicated by the prior topographic map.

Other data 340 can include a variety of other data, such as historical data relative to operations on the worksite, historical data relative to characteristics and conditions of the worksite (e.g., historical topographic characteristics) or the environment of the worksite (e.g., historical data relative to prior events), as well as historical data indicative of the occurrence of topographic changes to the worksite due to various events (e.g., weather). This type of information can be used by topographic confidence system 330 to determine a likelihood of a change in topographic characteristics occurring or having occurred presently.

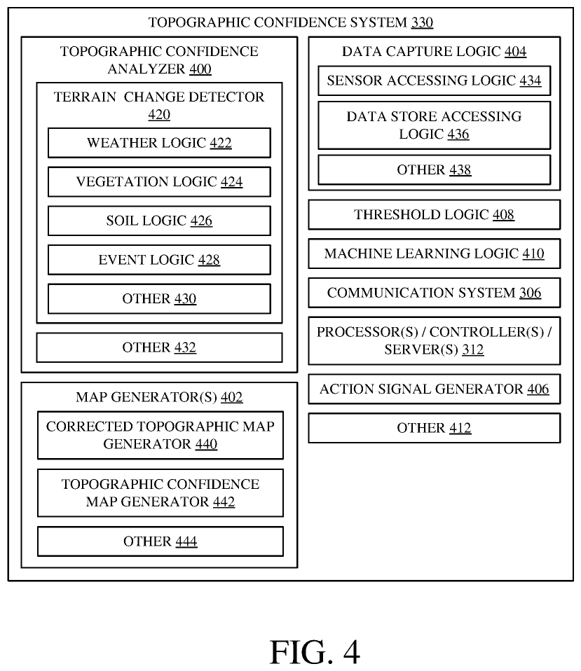

FIG. 4 is a block diagram illustrating one example of topographic confidence system 330 in more detail. Topographic confidence system 330 can include communication system 306, one or more processors, controllers, or servers 312, topographic confidence analyzer 400, map generator(s) 402, data capture logic 404, action signal generator 406, threshold logic 408, machine-learning logic 410, and can include other items 412 as well. Topographic confidence analyzer 400, itself, can include terrain change detector 420 and it can include other items 432 as well. Map generator(s) 402, itself, can include corrected topographic map generator 440, topographic confidence map generator 442, and can include other items 444 as well. Data capture logic 404, itself, can include sensor accessing logic 434, data store accessing logic 436, and it can include other items 438 as well.

In operation, topographic confidence system 330 determines a confidence level in the topographic characteristics relative to a worksite as indicated by a prior topographic map of the worksite, based on available supplemental data relative to the worksite or the environment of the worksite. Topographic confidence system 330 can generate a variety of topographic confidence outputs, such as various representations of the topographic confidence level, a corrected topographic map, or a topographic confidence map, as well as various other outputs. Topographic confidence system 330 can generate action signals to control the operation of various components of computing architecture 300 (e.g., mobile machine 100, vehicles 370, remote computing systems 368, etc.), as well as to control the operation of various components or items of the components of computing architecture 300, such as controllable subsystems 302 of mobile machine 100. Further, topographic confidence system 330 can generate action signals to provide indications such as displays, recommendations, alerts, notifications, as well as various other indications on an interface or interface mechanism, such as on operator interfaces 360 or user interfaces 364. The indications can include audio, visual or haptic outputs.

The topographic confidence level can be indicative of a confidence that the topographic characteristics of the worksite are the same (or substantially the same) or are otherwise accurately or reliably represented by the topographic characteristics in the prior topographic map of the worksite. In some examples, the topographic confidence level can indicate a likelihood that the topographic characteristics of the worksite, as indicated by the prior topographic map, have changed, or the topographic confidence level can indicate a likelihood that the topographic characteristics of the worksite, as indicated by the prior topographic map, are the same (or substantially the same) or are otherwise accurately or reliably represented by the prior topographic map of the worksite. In some examples, a representation of the topographic confidence level can indicate both the likelihood that the topographic characteristics of the worksite, as indicated by the prior topographic map, are the same (or substantially the same) or are otherwise accurately or reliably represented by the topographic characteristics in the prior topographic map, and a likelihood that the topographic characteristics, as indicated by the prior topographic map, have changed. For instance, a representation in the form of a percentage, such as “80%” can indicate an 80% likelihood that the topographic characteristics of the worksite are the same (or substantially the same) or are otherwise accurately or reliably represented by the prior topographic map, and therefore the representation simultaneously indicates a 20% likelihood that the topographic characteristics of the worksite have changed. This is merely an example.

Data capture logic 404 captures or obtains data that can be used by other items in topographic confidence system 330. Data capture logic 404 can include sensor accessing logic 434, data store accessing logic 436, and other logic 438. Sensor accessing logic 434 can be used by topographic confidence system 330 to obtain or otherwise access sensor data (or values indicative of the sensed variables/characteristics) provided from sensors 310, as well as other sensors such as sensors 382 of vehicles 370, that can be used to determine a topographic confidence level. For illustration, but not by limitation, sensor accessing logic 434 can obtain sensor signals indicative of characteristics relative to a topography of the worksite at which mobile machine 100 or vehicles 300 are operating. Such characteristics may be indicative of a change in the topography of the field such as a gully or rill, a ridge of soil, a washout, as well as various other characteristics.

Additionally, data store accessing logic 436 can be used to obtain or otherwise access data previously stored on data stores 308 or 378, or data stored at remote computing systems 368. For example, this can include map data 336, supplement data 338, as well as a variety of other data 340.

Upon obtaining various data, topographic confidence analyzer 400 analyzes the data to determine a confidence level in the topographic characteristics indicated or otherwise provided by a prior topographic map. The analysis can include, in one example, a comparison of the characteristics on the prior topographic map to the obtained data, such as supplemental data 338. Topographic confidence analyzer 400 can include terrain change detector 420, and it can include other items 432. Terrain change detector 420, itself, can include weather logic 422, vegetation logic 424, soil logic 426, event logic 428, and various other logic 430 as well.

Based upon the topographic confidence level, topographic confidence system 330 can use action signal generator 406 to generate a variety of action signals to control the operation of the components of computing architecture 300 (e.g., mobile machine 100, remote computing systems 368, vehicles 370) or to provide indications, such as displays, recommendations, or other indications (e.g., alerts) on an interface or interface mechanisms. The indications can include audio, visual, or haptic outputs. For instance, based on the topographic confidence level, topographic confidence system 330 can generate an action signal to control the position of various components of mobile machine 100 (e.g., position of header 104, position of boom 210, etc.). In another example, based on the topographic confidence level, a display, recommendation, and/or other indication can be generated and surfaced to an operator 362 on an operator interface 360 or to a remote user 366 on a user interface 364. Based on the generated displays, operators 362 or remote users 366 can manually (e.g., via an input on an interface) adjust the settings or operation of a component of computing architecture 300. These are merely examples, and topographic confidence system 330 can generate any number of action signals used to control any number of settings or operations of any number of machines or to generate any number of displays, recommendations, or other indications.

It will be noted that topographic confidence analyzer 400, can implement or otherwise utilize a variety of techniques, such as various image processing techniques, statistical analysis techniques, various models (e.g., soil model, soil erosion model, vegetation model, as well as various other models), numeric equations, neural networks, machine learning, knowledge systems (e.g., expert knowledge systems, operator or user knowledge systems, etc.), fuzzy logic, rule-based systems, as well as various other techniques and any combinations thereof.

Terrain change detector 420 detects change (e.g., deviation) or a likelihood of change to the characteristics of the worksite from the characteristics indicated by the prior topographic map. In some examples, detecting a change comprises detecting a change or a likely change in the topographic characteristics of the worksite, not indicated by the prior topographic map. In other examples, detecting a change comprises detecting a characteristic of the worksite or a characteristic of the environment of the worksite that is indicative of a likely change to the topographic characteristics of the worksite. For instance, the detection of weather conditions (e.g., heavy rain, as well as a variety of other characteristics) or weather events (e.g., flood), that indicate a likely change to the topographic characteristics of the worksite. In another example, the detection of characteristics of the worksite (e.g., downed crop, an area of the field with decelerated crop growth, as well as a variety of other characteristics), that indicate a likely change to the topographic characteristics of the worksite. It will be noted that while a single characteristic can indicate a change or a likely change in the topographic characteristics of the worksite, it can also be that a variety of characteristics form the basis for the detection or determination that a change or likely change has occurred. For example, such characteristics can include a consideration of the weather conditions (e.g., precipitation level), the soil characteristics of the worksite or of a particular area of the worksite, and the previously known slope of the worksite or particular area of the worksite.

Weather logic 422 is configured to analyze weather data accessed from data stores, received from sensors, such as weather sensors 350, or operator or user inputs, or other sources such as remote weather services or stations. Weather logic 422 determines if a change in the topography of the worksite (as indicated by the prior topographic map) has changed or is likely to have changed. For instance, weather logic 422 can receive various data indicative of weather conditions that occurred in the time after the data was collected for the prior map, such as precipitation types and levels (e.g., hail, rain, snow, various other precipitation), temperature, humidity, wind speeds and direction, and various other weather conditions. As an example, assume that weather logic 422 receives weather data that indicates that the worksite received a 4″ rainfall over a certain time period (e.g., 24 hours). Weather logic 422 can determine that a change in the topographic characteristics of the worksite or of particular geographic locations within the worksite (such as a washout) has occurred or has likely occurred. This determination can be based solely on the weather data, or it can be based on a combination of the weather data and other characteristics of the worksite or the environment such as tillage history, residue cover, soil compaction, soil type, slope, or various other soil characteristics.

In another example, weather logic 422 can receive or otherwise obtain various data indicative of weather events that occurred in the time after the data for the prior map was collected, such as storms, tornadoes, hurricanes, tsunamis, floods, high winds, as well as various other weather events. For example, weather logic 422 can receive weather data that indicates that the worksite flooded and can determine that a change in the topographic characteristics of the worksite or of particular geographic locations within the worksite has occurred or has likely occurred. Weather logic 422 can make these determinations based on various models, such as weather models, river gage readings, as well as various other models.

Vegetation logic 424 is configured to analyze vegetation data which may be accessed from data stores, received from sensors, such as imaging sensors that image the worksite during a fly-over, as well as various other sources of vegetation data. Vegetation logic 424 determines whether a change in the topography of the field from that indicated by the prior topographic map) has occurred or is likely to have occurred. For instance, vegetation logic 424 can receive various data indicative of vegetation characteristics or conditions that occurred or otherwise presented in the time after the data for the prior map was collected. This data can include crop state data (e.g., data indicating crop health, growth, standing, blown over, down crop, down crop direction, as well as various other crop state data), vegetation type (e.g., crop type, weed type, cultivar or hybrid, etc.), crop stage, crop stress, crop density, crop height, leaf area index (LAI), vegetation index (VI) data, including, for example, Normalized Difference Vegetation Index (NDVI), as well as various other vegetation data. For example, vegetation logic 424 can receive vegetation data (e.g., LAI, NDVI, etc.) that indicates that the vegetation is less vigorous than an expected level at the worksite or at particular geographic locations of the worksite and can determine that a change in the topographic characteristics of the worksite or of particular geographic locations within the worksite has occurred or has likely occurred. For instance, less vigorous vegetation growth or density, as well as vegetation state data that indicates less healthy vegetation, can be an indicator of a change in a topographic characteristic of the worksite, such as the development of a rill, gully, or washout, as well as material deposit. This determination can be based solely on the vegetation data, or it can be based on a combination of the vegetation data and other characteristics of the worksite or the environment of the worksite. For example, based on the vegetation data (e.g., growth, health, crop state, etc.) and weather data (e.g., level of rainfall), vegetation logic 424 can determine that a washout likely occurred at the worksite or at a particular geographic location within the worksite.

In another example, vegetation logic 424 can receive vegetation data that indicates that vegetation that has been blown over or is otherwise down or bent, rather than standing as it should. The vegetation data may indicate wind-blown tumbleweeds or other vegetation debris on the worksite and can determine that a change in the topographic characteristics of the worksite or of particular geographic locations within the worksite has occurred or has likely occurred. For instance, the detection of blown vegetation can indicate sediment or material drift, such as erosion (e.g., the reduction of soil levels) or deposit (e.g., the build-up of soil levels, such as a soil ridge) due to high winds, flooding, etc. This determination can be based solely on the vegetation data, or it can be based on a combination of the vegetation data and other characteristics of the field. Additionally, vegetation logic 424 can make these determinations based on various models, such as a crop model, as well as various other models.

Soil logic 426 is configured to analyze soil data accessed from data stores, received from sensors such as soil characteristic sensors, or received from operator or user inputs, as well as various other sources of soil data. Soil logic 426 can determine whether a change in the topography of the worksite from that indicated by the prior topographic map has occurred or is likely to have occurred. For instance, soil logic 426 can receive various data indicative of soil characteristics that presented in the time after the data for the prior map was collected, such as soil type, soil compaction, soil structure, soil surface features (e.g., rills, gullies, washouts, erosion, deposits, etc.), soil moisture, soil composition, soil cover (e.g., residue level, such as crop residue) as well as various other soil characteristics. For example, soil logic 426 can receive soil data that indicates that the soil at the worksite or at particular geographic locations within the worksite is at a certain level of compaction and based on the compaction level and the amount of wind or rain, soil logic 426 may determine that it is more or less likely that some erosion occurred.

In other examples, this determination can be based solely on the soil data or on a combination of soil data and other characteristics of the worksite or the environment of the worksite. For example, erosion can be more or less likely based on the type of soil (e.g., loose topsoil, clay base, sandy, etc.), how much wind or rain the worksite has experienced, as well as the amount of crop residue left on the worksite (e.g., from a previous harvest) to absorb the moisture or provide cover from the wind. Soil logic 426 can determine that a change in the topographic characteristics of the worksite or of particular geographic locations in the worksite has occurred or has likely occurred based on the soil data (e.g., soil type, soil composition, as well as various other soil data), weather data (e.g., level of rainfall, wind, weather events, as well as various other weather data), as well as vegetation data (e.g., level of crop residue coverage on the worksite) as well as various other data. Additionally, soil logic 426 can make these determinations based on a variety of models, such a soil erosion models, sediment transport models, water runoff models, geomorphological models, as well as various other models.

Event logic 428 is configured to analyze event data accessed from data stores, received from sensors, received from operator or user inputs, as well as various other sources of event data, such as news sources. Event logic 428 can determine whether a change in the topography of the worksite from that indicated by the prior topographic map has occurred or is likely to have occurred. For instance, event logic 428 can receive various data indicative of events that occurred in the time after the data for the prior map was collected, such as, event data indicative of the occurrence of natural events (e.g., volcanoes, fires, earthquakes, as well as various other natural events) as well as event data indicative of human activity, as well as various other event data. As an example, event logic 428 can receive event data that indicates that a fire or a volcano eruption occurred near (or near enough) to the worksite such that ash from fire(s) or volcano(es) or other sediment deposit may have occurred and can determine that a change in the topographic characteristics of the worksite or of particular geographic locations within the worksite has occurred or has likely occurred. This determination can be based solely on the event data, or it can be based on a combination of the event data and other characteristics of the worksite or the environment of the worksite. For example, event logic 428 can determine that sediment deposit has occurred or has likely occurred at the worksite or at a particular geographic location within the worksite based on the event data indicating the occurrence of a fire or a volcano eruption and weather characteristics (e.g., wind speed and direction during time of fire or volcano eruption).

In another example, event logic 428 can receive various event data indicative of the occurrence of non-natural activities occurring at the worksite in the time after the data for the prior map was collected, such as event data that indicates that another operation occurred (e.g., agricultural planting operation, agricultural spraying operation, agricultural tillage operation, agricultural irrigation operation, etc.) or event data that indicates the occurrence of an event during another operation (such as a machine getting stuck at a location in the field). and can determine that a change in the topographic characteristics has occurred or has likely occurred. For instance, event logic 428 can receive event data indicative of a planting operation occurring at the worksite after the data for the prior map was collected and before the harvesting operation is to be performed, and determine that a change in the topographic characteristics at the worksite or at particular geographic locations within the worksite has occurred or has likely occurred. In other examples, event logic 428 can receive event data indicative of a tillage operation occurring at the worksite after the data for the prior map was collected and before the harvesting operation is to be performed, and determine that a change in the topographic characteristics at the worksite or at particular geographic locations within the worksite has occurred or has likely occurred, such as a ridge tilling operation creating tilled ridges. In another example, event logic 428 can receive event data indicative of an irrigation operation occurring at the worksite after the data for the prior map was collected and before the harvesting operation is to be performed, and determine that a change in the topographic characteristics at the worksite or at particular geographic locations within the worksite has occurred or has likely occurred, such as ruts being formed in the soil during the irrigation operation. Event logic 428 can, in making such a determination, also consider various other data, such as soil moisture data, to determine the likelihood of a change in the topographic characteristics of the field, such as the occurrence of ruts due to the planting operation. These are merely examples. Additionally, event logic 428 can make these determinations using various models, such as sediment drift or deposit models, ash drift models, earthquake models, as well as various other models.

Other logic 430 can include various other logic configured to analyze a variety of other data (e.g., accessed from data store(s), received from sensor(s), operator/user inputs, as well as various other sources of data) and determine if a change in the topography of the worksite (as indicated by the prior topographic map) has occurred or is likely to have occurred.

It will be understood that the determination(s) that a change in the topography of a worksite of particular geographic locations within the worksite has occurred or has likely occurred can be based on a single type of data or on a combination of data, as well on a single characteristic or on a combination of various characteristics. In some examples, the number of indications can affect the topographic confidence level. For instance, the presence of a single characteristic (e.g., blown vegetation) can indicate that a topographic change has occurred or has likely occurred, however the presence of multiple characteristics can indicate that a topographic change has occurred or has likely occurred to a greater or lesser degree. For example, while an indication that some crop is down or that there is less crop growth at a certain location on the worksite can indicate the presence of, for example, a washout, that indication combined with, for instance, weather data that indicates heavy rain or flooding can affect the confidence value in the topographic features of that particular location (as indicated by the prior topographic map) to a greater degree. For example, it can lead to determination that a washout has occurred to a relatively high degree of likelihood. Similarly, an indication that some crop is down or that there is less growth at a certain location on the worksite, without an accompanying indication that the worksite has experience heavy rain or flooding can affect the confidence value to a lesser degree. For example, it can lead to a determination that a washout may have occurred with a relatively low degree of likelihood. These are merely examples.

Map generator(s) 402 are configured to generate a variety of maps based on the prior map(s) and the supplemental data. In some examples, the supplemental data provides an indication of a detectable change in the topographic characteristics of the worksite. In such a case, corrected topographic map generator 440 can incorporate the changed topographic characteristics indicated by the supplemental data with the prior topographic map to generate a corrected topographic map. For example, in some instances, characteristics of the worksite may be detectable or visible to various sensor(s) used to generate supplemental data such that a change in the topographic characteristics of the worksite (as indicated by the prior map) can be determined with a degree of certainty. For instance, the occurrence or presentation of a ridge, a washout, a gully, a rill, as well as various other characteristics may be clearly detectable such that their presence can be detected. In such a case, the corrected topographic map generated by corrected topographic map generator 440 will reflect the change in the topography of the worksite.

In some examples, the supplemental data provides an indication of a characteristic or a condition at the worksite or the environment of the worksite that can indicate that a change in the topography of the worksite has likely occurred, but cannot be confirmed with a level of certainty by the system(s) (e.g., sensor(s)) or humans collecting or otherwise inputting the data). This can be the case when a surface of the worksite is not visible due to vegetation coverage or due to various other obscurants. In such examples, topographic confidence map generator 442 can generate a topographic confidence map that indicates, among other things, the topographic confidence value at the worksite or at particular geographic locations within the worksite. The topographic confidence map (some examples of which are provided below) can be generated as an interactive map layer on an interactive map such that the user or operator is able to manipulate the functionality of the map layer or the map. For instance, the user or operator may be able to switch the display between the topographic confidence map and the prior topographic map, or to generate a split-screen with one part showing the prior topographic map and another part showing the topographic confidence map. Additionally, the user or operator can manipulate the display of the confidence value representation for the worksite or for particular geographic locations of the worksite, such as by changing the representation of the confidence value, or by displaying both the representation of the confidence value and the corresponding topographic characteristic as indicated by the prior topographic map. Additionally, the map display may further include an indication of the location of mobile machine 100 on the worksite as represented by the map. These are merely examples.

It will also be understood that map generator(s) 402 can, in some examples, generate a map that includes corrected topographic characteristics and topographic confidence levels. For example, for the areas of the worksite where the topographic characteristics can be detected with a degree of certainty (e.g., the surface of the worksite is actually visible or otherwise detectable), corrected or updated topographic characteristics can be provided, and for the areas of the worksite where the topographic characteristics cannot be detected with a degree of certainty (e.g., the surface of the worksite is not visible) a topographic confidence level for those areas can be provided. In this way, the map can be a mix of corrected topographic characteristics and topographic confidence levels.

As illustrated in FIG. 4, topographic confidence system 330 can include action signal generator 406. Action signal generator 406 can generate a variety of action signals, used to control an action of components of computing architecture 300. For instance, action signal(s) can be used to control an operation of mobile machine 100, such as raising or lowering header 104, raising or lowering boom 210, adjusting a speed of mobile machine 100, adjusting a heading of mobile machine 100, adjusting the operation of spraying subsystem, as well as a variety of other operations or machine settings. In another example, action signal(s) are used to provide displays, recommendations, and/or other indications (e.g., alerts) on an interface or interface mechanism, such as to an operator 362 on an operator interface 360 or to a remote user 366 on a user interface 364. The indications can include audio, visual, or haptic outputs. The indication can be indicative of the topographic confidence value or representation of the topographic confidence value, a corrected topographic map, a topographic confidence map, as well as a variety of other displays. Additionally, action signal generator 406 can generate action signals to control the operation of vehicles 370 to, for instance, travel to locations on the worksite to further scout the locations to collect additional data. Similarly, action signals can be generated to recommend to the operator or user to send out a human scout to locations on the worksite to further scout the locations to collect additional data. In other examples, action signal generator 406 can generate action signals to direct (such as by providing an indication on an interface mechanism) a human to drive, ride, or walk to an area to scout the area to collect additional data. This may include visually scouting the area or the assistance of various sensing devices (such as handheld devices) operated by the human or included on a vehicle operated by a human. The direction may be given by at least one of audio, visual, or haptic guidance. These are merely examples. Topographic confidence system 330 can generate any number of a variety of action signal(s) used to control any number of actions of any number of components of computing architecture 300.

Threshold logic 408 is configured to compare various characteristics of the worksite to a variety of thresholds. The thresholds can be automatically generated by system 330 (such as by machine learning logic 410), input by an operator or a user, or generated in various other ways. For example, thresholds may be used to determine a level of deviation from an expected value, or a level of deviation from the surrounding areas of the worksite to determine areas of the worksite that may have topographic characteristic changes. For instance, if the crop growth of crops (as measured by NDVI) at a particular geographic location within the worksite deviates by a threshold amount from an expected level of crop growth or as compared to crops in the surrounding areas of the worksite, then terrain confidence system 330 can be controlled to generate a topographic confidence value for the worksite or the particular geographic location within the worksite, indicating that a topographic change may be likely.

Additionally, threshold logic 408 is configured to compare the various topographic confidence values to a variety of thresholds. The thresholds can be automatically generated by system 330 (such as by machine learning logic 410), input by an operator or a user, as well generated in various other ways. The thresholds can be used to determine how much the topographic characteristics of the worksite (as indicated by supplemental data and the corresponding topographic confidence level) can deviate from the topographic characteristics indicated by the preexisting topographic map before a control of the machine(s) is adjusted or before a display, recommendation, or other indication (e.g., alert) is provided on an interface or interface mechanism. The indication can include audio, visual, or haptic outputs. For instance, an operator or a user can input a threshold of 95% topographic confidence level, such that, only when the topographic confidence level is below 95% is some action signal generated. Additionally, the threshold may be used in the assignment of representations of the confidence value. For instance, in the example of “high, medium, and low” as representations of the topographic confidence level, a threshold may indicate a range of topographic confidence levels to assign to each representation. For example, 90%-99% may be represented as “high”, 70%-89% may be represented as “medium”, and anything below 70% may be represented as “low.” This is merely an example.

FIG. 4 also shows that topographic confidence system 330 can include machine learning logic 410. Machine learning logic 410 can include a machine learning model that can include machine learning algorithm(s), such as, but not limited to, memory networks, Bayes systems, decision tress, Eigenvectors, Eigenvalues and Machine Learning, Evolutionary and Genetic Algorithms, Expert Systems/Rules, Engines/Symbolic Reasoning, Generative Adversarial Networks (GANs), Graph Analytics and ML, Linear Regression, Logistic Regression, LSTMs and Recurrent Neural Networks (RNNSs), Convolutional Neural Networks (CNNs), MCMC, Random Forests, Reinforcement Learning or Reward-based machine learning, and the like.

Machine learning logic 410 can improve the determination of topographic confidence levels by improving the algorithmic process for the determination, such as by improving the recognition of characteristics and conditions of the worksite or the environment of the worksite that indicate modifications to the topographic characteristics of the worksite. For example, machine learning logic 410 can learn relationships between characteristics, factors, or conditions that affect the topography of the worksite. Machine learning logic 410 can also utilize a closed-loop style learning algorithm such as one or more forms of supervised machine learning.

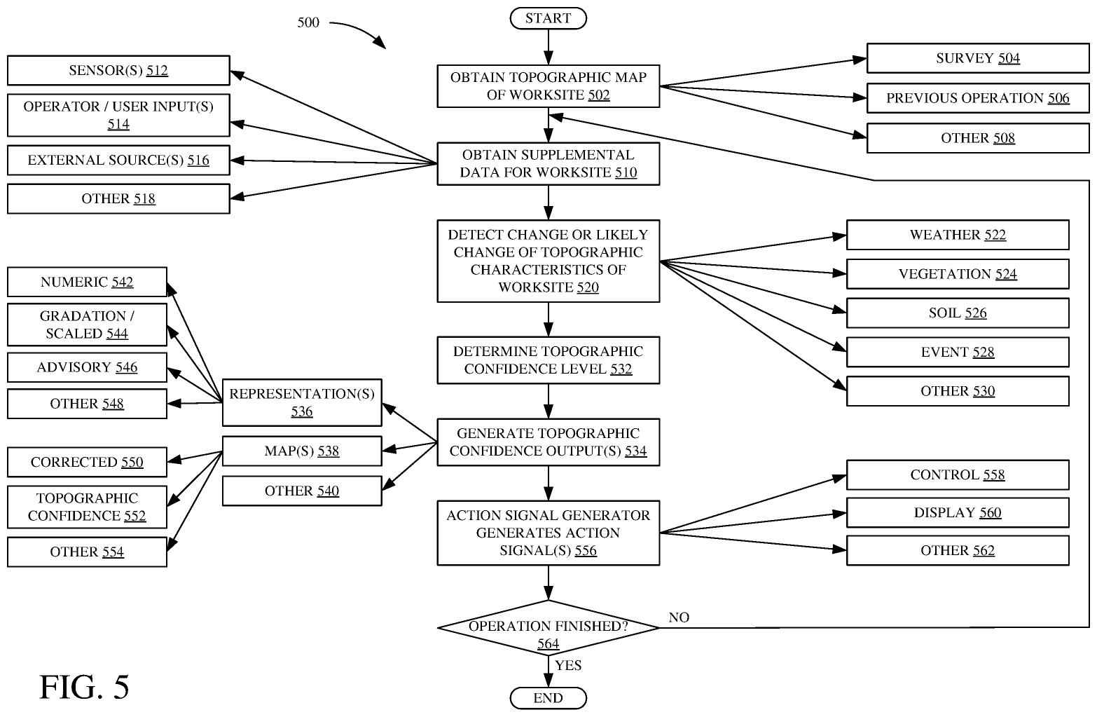

FIG. 5 is a flow diagram showing an example of the operation of the topographic confidence system 330 shown in FIG. 4 in determining a confidence in the topographic characteristics of the worksite as indicated by a prior topographic map based on supplemental data and generating a topographic confidence output based on the determination. It is to be understood that the operation can be carried out at any time or at any point through an agricultural operation, or even if an agricultural operation is not currently underway. Further, while the operation will be described in accordance with mobile machine 100, it is to be understood that other machines with a topographic confidence system 330 can be used as well.

Processing begins at block 502 where data capture logic 404 obtains a topographic map of a worksite. The topographic map can be based on a survey of the worksite (e.g., an aerial survey, a satellite survey, a survey by a ground vehicle, etc.) as indicated by block 504, data from a previous operation on the worksite (e.g., row data, pass data, etc.) as indicated by block 506, as well as based on various other data, as indicated by block 508.

Once a topographic map of the worksite has been obtained at block 502, processing proceeds at block 510 where data capture logic 404 obtains supplemental data for the worksite. The supplemental data can be obtained or otherwise received from various sensor(s) as indicated by block 512, operator/user input as indicated by block 514, various external sources (e.g., weather stations, the Internet, etc.) as indicated by block 516, as well as from various other sources of supplemental data, as indicated by block 518.

Once the data is obtained at blocks 502 and 510, processing proceeds at block 520 where, based on the topographic map and the supplemental data, terrain change detector 420 of topographic confidence system 330 detects a change or a likely change in the topographic characteristics of the worksite (as indicated by the topographic map) based on characteristics of the worksite or the environment of the worksite as indicated by the supplemental data. These characteristics can be weather characteristics indicated by weather data and analyzed by weather logic 422 as indicated by block 522, vegetation characteristics indicated by vegetation data and analyzed by vegetation logic 424 as indicated by block 524, soil characteristics indicated by soil data and analyzed by soil logic 426 as indicated by block 526, event characteristics indicated by event data and analyzed by event logic 428 as indicated by block 528, as well as a variety of other characteristics analyzed by various other logic, as indicated by block 530.

Processing proceeds at block 532 where, based on the detected change or likely change to the topographic characteristics of the worksite, topographic confidence analyzer 400 of topographic confidence system 330 determines a topographic confidence level indicative of a confidence in the topographic characteristics of the worksite or the topographic characteristics of particular geographic locations within the worksite, as indicated by the topographic map.

Processing proceeds at block 534 where, based on the topographic confidence level(s), topographic confidence system 330 generates topographic confidence output(s). The topographic confidence outputs can include representation(s) of the topographic confidence level(s) as indicated by block 536, maps as indicated by block 538, as well as various other outputs, as indicated by block 540. The representations(s) at block 536 can include numeric representations, such as percentages or scalar values, as indicated by block 542, gradation and/or scaled values, such A-F, “high, medium, low”, 1-10, as indicated by block 544, advisory representations, such as caution, proceed, slow, scout first, no crop, as indicated by block 546, as well as various other representations, including various other metrics and/or values, as indicated by block 548.

The maps at block 538 can be generated by map generator(s) 402 and can include corrected topographic maps as indicated by block 550, topographic confidence maps as indicated by block 552, as well as various other maps, as indicated by block 554. In one example, other maps can include a map that includes both corrected topographic information and topographic confidence level(s).

In one example, once topographic confidence output(s) have been generated at block 534, processing proceeds at block 556 where action signal generator 406 generates one or more action signal(s). In one example, action signals can be used to control the operation of one or more machines, such as one or more controllable subsystems 302 of mobile machine 100, vehicles 370, etc., as indicated by block 558. For instance action signal generator 406 can generate action signals to control the speed of mobile machine 100, or the route of mobile machine 100, adjust the position of header 104 or boom 210 above the surface of the worksite, adjust an operating parameter of the spraying subsystem of sprayer 201, as well as a variety of other operations or machine settings. In another example, a display, recommendation, or other indication can be generated to an operator 362 on an operator interfaces 360 or to a remote user 366 on a user interface 364. The display can include an indication of the topographic confidence level, a display of a map, such as a corrected topographic map or a topographic confidence map. Any number of various other action signal(s) can be generated by action signal generator 406 based on the topographic confidence output(s), as indicated by block 562.

Processing proceeds at block 564 where it is determined whether the operation of mobile machine 100 is finished at the worksite. If, at block 564, it is determined that the operation has not been finished, processing proceeds at block 510 where additional supplemental data is obtained. If, at block 564, it is determined that the operation has been finished, then processing ends.

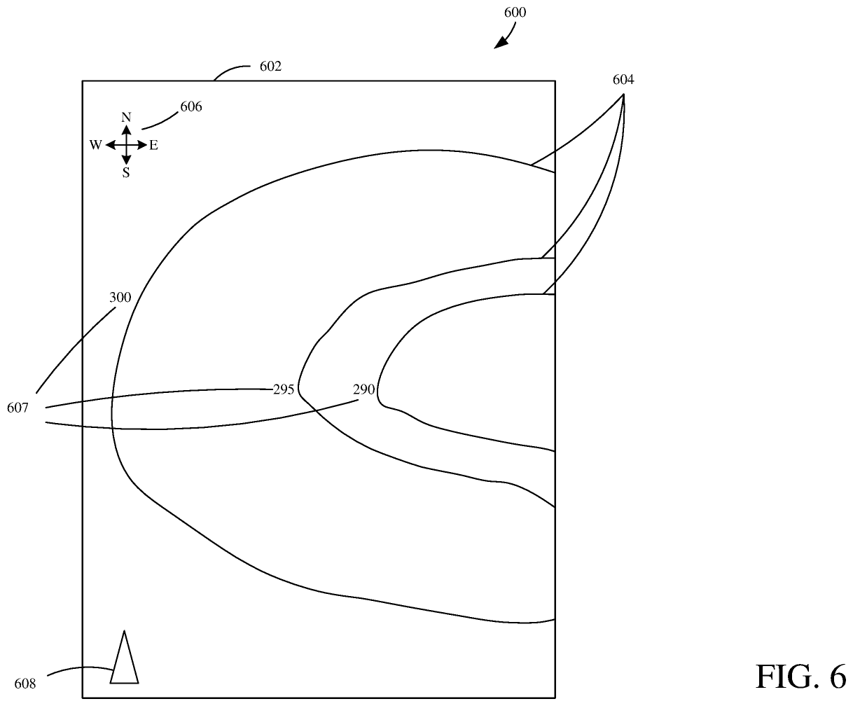

FIGS. 6-11 are pictorial illustrations of examples of the various maps that can be used by or generated by a topographic confidence system 330 shown in FIG. 4.

FIG. 6 is one example of a prior topographic map 600 of a worksite that can be obtained and used by topographic confidence system 330. Prior topographic map 600 shows topographic characteristics of worksite 602 upon which mobile machine 100 is to operate. Topographic map 600 can include contour lines 604, compass rose 606, topographic representations 607, and mobile machine indicator 608. While certain items are illustrated in FIG. 6, it will be understood that topographic map 602 can include various other items. Generally speaking, prior topographic map 600 indicates topographic characteristics of worksite 602 such as elevation of a surface of worksite 602 relative to a reference value (typically sea level) as indicated by topographic representations 607. Topographic map 600 further includes compass rose 606 to indicate the disposition of worksite 602 and items on map 600 or worksite 602 relative to North, South, East, and West. Topographic map 600 can further include an indication of the position and/or heading of mobile machine 100, as represented by indicator 608 which is shown in the southwestern corner of worksite 602 heading North. Contour lines 604 can further indicate, beyond a location of the elevation as represented by topographic representations 607, other topographic characteristics, such as characteristics of the slope of worksite 602. For instance, the distance between contour lines 604 generally indicates the slope of terrain at worksite 602.

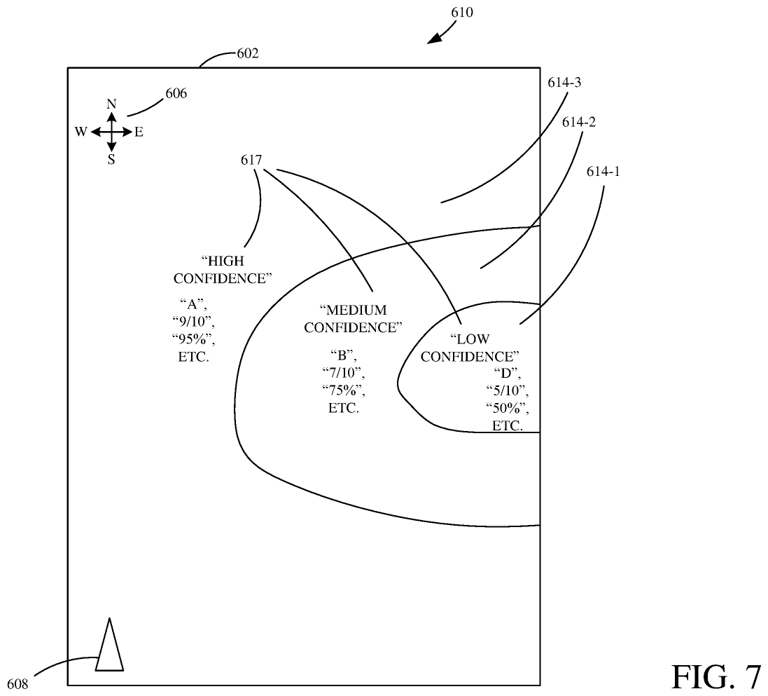

FIG. 7 is one example of a topographic confidence map 610 that can be generated by topographic confidence system 330, based on a prior topographic map, such as map 600 and supplemental data relative to worksite 602 or the environment of worksite 602. Topographic confidence map 610 generally indicates a confidence level in the topographic characteristics of worksite 602 that are shown on prior topographic map 600. As can be seen, topographic confidence map 610 can include topographic confidence zones 614 (shown as 614-1 to 614-3) and topographic confidence level representations 617. A number of different examples of topographic confidence level representations 617 are shown in FIG. 7. For instance, FIG. 7 shows that representations 617 can be numeric representations (e.g., 95%) as well as gradation and/or scaled representations (e.g., A-F, 1-10, “high, medium, low”, etc.). As can be seen, the topographic confidence level and the corresponding topographic confidence level representations can vary across worksite 602, as indicated by confidence zones 614-1 to 614-3.

In one example, topographic confidence system 330 may have received supplemental data indicating that worksite 602 received heavy rain (e.g., 4 inches in an hour), that the crop residue cover on worksite 602 is only 5%, and that the tillage direction is east-to-west. Based on this supplemental data, topographic confidence system 330 can determine that a change in the topographic characteristics of worksite 602 and/or of particular geographic locations within worksite 602 has occurred or has likely occurred. For example, based on the topographic characteristics (such as elevation, slope, etc.), as indicated by prior topographic map 600, of worksite 602, the amount of rainfall, the tillage direction and the amount of crop residue cover, topographic confidence system 330 can determine that the area of the field represented by 614-1 likely experienced a change in topography due to a washout on worksite 602 (which likely caused a change in topography, such as material or sediment build-up in the area of the field represented by 614-1), and thus indicates that the confidence level in the topographic characteristics for that area is “low” (or some other representation). This is because material and sediment from higher areas on the field (such as 614-2) may wash away and accumulate in a lower and flatter areas of the field (such as 614-1) when the worksite 602 experiences heavy rain. Additionally, due to the relative size of the area of the field represented by 614-1, the amount or severity of deviation from the topographic characteristics of that area, as indicated by the prior topographic map, may be greater, and thus the confidence may be relatively lower. Similarly, while the area represented by 614-2 may have experienced some change to the topographic characteristics, as indicated by the prior topographic map, due to the relative size of the area of the field represented by 614-2, the amount or severity of deviation from the topographic characteristics of that area, as indicated by prior topographic map, may be less, and thus the confidence value may be relatively higher. For instance, the confidence level for area 614-2 may be “medium” because a change may still have occurred in the area, but due to the relative size of the area, the change may be less likely to be significant (e.g., the change may be more gradual across the area). Extending further West on the worksite 602 into the area represented by 614-3, confidence system 330 can determine that a washout (or some other form of erosion) is unlikely to have occurred or at least that it is unlikely that something occurred which would affect or likely affect the topographic characteristics as indicated by prior topographic map 600, as compared to the areas represented by 614-1 and 614-2. Topographic confidence system 330 thus indicates that the confidence level in the topographic characteristics for that area is “high” (or some other representation). For instance, it may be “high” because area 614-3 is higher, flatter, and larger, as compared to surrounding areas of worksite 602, and thus the likelihood a change or a significant change to the topographic characteristics of area 614-3 may be less when the worksite 602 experiences heavy rain.

It will be noted that this is merely an example, and that various other characteristics of the worksite or the environment of the worksite, including various other characteristics indicated by supplemental data, can be considered by topographic confidence system 330. In the example provided, the topographic characteristics of elevation and slope, and the characteristics provided by the supplemental data, such as precipitation, tillage direction, and crop residue can have an effect on the amount of water runoff at worksite 602, and thus can affect the likelihood and/or level of erosion and/or material or sediment build-up or drift at worksite 602. Additionally, it is to be understood that topographic confidence system 330 can use any number of models in determining the topographic confidence level, for instance, in the provided example, a water runoff model or an erosion model.

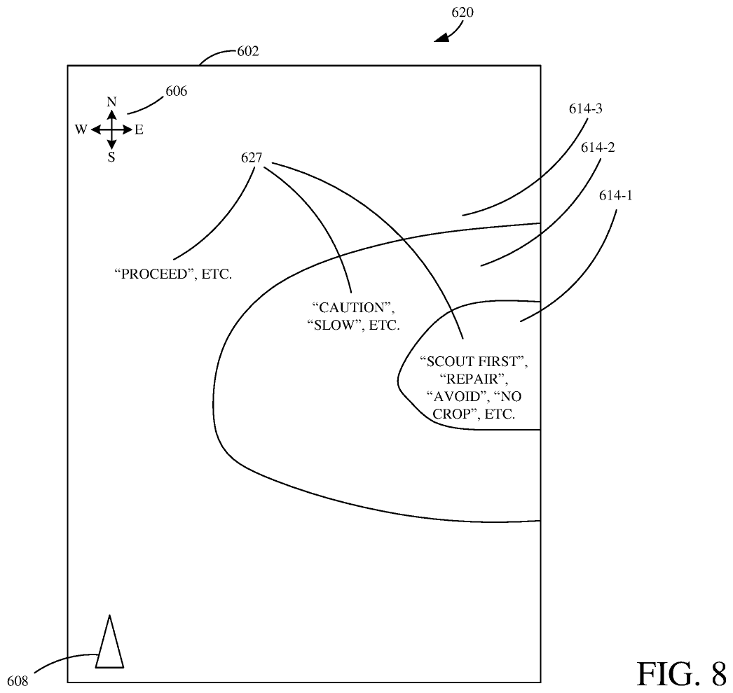

FIG. 8 is one example of a topographic confidence map 620 that can be generated by topographic confidence system 330, based on a prior topographic map, such as map 600 and supplemental data relative to worksite 602 and/or the environment of worksite 602. Topographic confidence map 620 is similar to topographic confidence map 610 except that the topographic confidence level is represented by advisory topographic confidence level representations 627, which can indicate an action to be taken or a recommendation of an action to be taken either while operating on worksite 602 or prior to operating on worksite 602. As described above, the topographic confidence level can vary across worksite 602, as represented by topographic confidence zones 614 (shown as 614-1 to 614-3). Each of the zones 614 can have a different advisory topographic confidence level as represented by 627. In this way, the control of machine 100 as it operates across worksite 602 can also vary depending on which confidence zone 614 it is operating within. In one example, confidence zones 614 can act as “control zones” for mobile machine 100 such that mobile machine 100 is controlled in a certain manner in one control zone as compared to another control zone.

For example, proceeding with the previous example provided above in FIG. 7, in zone 614-1 where it was determined that a change in the topographic characteristics likely occurred, or at least that the confidence level in the topographic characteristics as indicated by prior topographic map 600 is “low”, topographic confidence system 330 can provide an advisory topographic confidence level representation 627, such as, “scout first”, “avoid”, “no crop”, “repair”, as well as various other advisory representations. These advisory representations can be used to automatically control machine operation (e.g., by control system 304) or can be used by the operator/user to control the operation of various machines, such as mobile machine 100, vehicles 370, as well as various other components of computing architecture 300.

For instance, in the example of “scout first”, topographic confidence system 330 could generate an action signal to automatically control a vehicle (e.g., vehicles 370) to travel to zone 614-1 to collect further data (e.g., via sensors 382) prior to mobile machine 100 operating in zone 614-1, as well as generate an action signal to provide a display, alert, recommendation, or some other indication on an interface or interface mechanism (e.g., on operator interfaces 360, user interfaces 364, as well as various other interfaces or interface mechanisms) that zone 614-1 should first be scouted (e.g., by a human, by a vehicle, etc.) prior to mobile machine 100 operating there. The indication can include audio, visual, or haptic outputs. In other examples, topographic confidence system 330 can generate a route and an action signal to automatically control a heading of mobile machine 100 such that it travels along the edge of zone 614-1 but not into zone 614-1. In such an example, the mobile machine 100 can perform a scouting operation such that, as it travels along the edge of zone 614-1, sensors on-board mobile machine 100 (e.g., sensors 310) or operator 362 can detect characteristics within zone 614-1 prior to operating within zone 614-1. Topographic confidence system 330 can also generate an action signal to provide a display, alert, recommendation, or some other indication, such as a recommended route of mobile machine 100 across worksite 602, on an interface or interface mechanism. The indication can include audio, visual, or haptic outputs. Once additional data for area 614-1 is collected, the topographic confidence level can be dynamically redetermined by topographic confidence system 330 such that operation on worksite 602 can be adjusted. Additionally, in the event that the additional data has a sufficient level of certainty, topographic characteristics of zone 614-1 can be generated, such as in the form of a supplemented or corrected topographic map.

In the example of “avoid”, topographic confidence system 330 can generate a route and an action signal to automatically control a heading of mobile machine 100 such that it avoids traveling into zone 614-1, and to generate an action signal to provide a display, alert, recommendation, or some other indication, such as a recommended route of mobile machine 100 across worksite 602, on an interface or interface mechanism. The indication can include audio, visual, or haptic outputs. In one example of “avoid”, an advisory representation 627 of “no crop” can instead be displayed. For instance, it may be that the supplemental data indicates that there is no crop to be harvested in zone 614-1 and thus there is no need for mobile machine 100 to operate there, nor is there any need for additional scouting or collection of data.

In the example of “repair”, topographic confidence system 330 can generate an action signal to automatically control a machine (e.g., vehicle(s) 370) to travel to zone 614-1 to perform a repair operation on zone 614-1 to correct undesirable topographic characteristics (e.g., to fill in a washout, correct the build-up or drift of materials or sediments by regrading) and, in some examples, return the topography to the levels indicated by map 600, or to some other level as control system 304 or operators 362 or users 366 may desire or determine. Additionally, topographic confidence system 330 can generate an action signal to provide a display, alert, recommendation, or some other indication on an interface or interface mechanism that zone 614-1 should first be repaired (e.g., by a human, by vehicles 370, other machines, etc.) before operation of mobile machine 100 within zone 614-1. The indication can include audio, visual, or haptic outputs.

In zone 614-2 where, in the example of FIG. 7, it was determined that there was a possibility that a change in the topographic characteristics of worksite 602 occurred, or at least that the confidence level in the topographic characteristics indicated by prior topographic map 600 is “medium”, topographic confidence system 330 can provide an advisory topographic confidence level representation 627, such as, “caution”, “slow”, or various other advisory representations. These advisory representations can be used to automatically control machine operation (e.g., by control system 304) or can be used by the operator or user to control the operation of various machines, such as mobile machine 100, vehicles 370, as well as various other components of computing architecture 300.

For instance, in the example of “caution” or “slow”, topographic confidence system 330 can generate an action signal to automatically control a machine (e.g., by controlling the propulsion subsystem 318 of mobile machine 100) to travel at a slower speed throughout zone 614-2 as compared to other zones or at a speed slow enough for sensor signals generated by sensors on-board the machine (e.g., sensors 310) to be used to control the operation of the machine in a timely enough fashion to avoid consequences of topographic conditions on worksite 602. As an example, propulsion subsystem 318 of mobile machine 100 may be controlled to propel mobile machine 100 at a speed which allows a sensor signal generated by perception system(s) 342 indicative of an upcoming washout or build-up of material, to be used to adjust the height or orientation of header 104 or boom 210 to compensate for the topographic change caused by the upcoming washout or build-up of material so that header 104 won't run into the ground or miss the crop, or so that boom 210 will remain at a desired position, such as above the crop canopy. Additionally, topographic confidence system 330 can generate an action signal to provide a display, alert, recommendation, or some other indication on an interface or interface mechanism, such as an indication to the operator or user that the speed of the machine should be reduced, an indication that the operator should pay particularly close attention to the worksite surface ahead of the machine, or various other indications. The indication can include an audio, visual, or haptic output.

In zone 614-3, in the example of FIG. 7, it was determined that a change in the topographic characteristics of worksite 602 was unlikely, or at least that the confidence level in the topographic characteristics as indicated by prior topographic map is “high”. Therefore, topographic confidence system 330 can provide an advisory topographic confidence level representation 627, such as, “proceed” or various other advisory representations. For example, topographic confidence system 330 can generate an action signal to automatically control a machine (e.g., mobile machine 100) to operate based on the topographic characteristics indicated by prior topographic map 600. Additionally, topographic confidence system 330 can generate an action signal to provide a display, alert, recommendation, or some other indication on an interface or interface mechanism to the operator or user so the operator or user can use prior topographic map 600 for operating mobile machine 100. The indication can include an audio, visual, or haptic output. Topographic confidence system 330 can generate control signals to control various other components of computing architecture 300, as well as various other machines, at least while in zone 614-3.

Indicator 608 provides an indication of the location and heading of mobile machine 100 on worksite 602, and, in some examples, topographic confidence system 330 can generate an action signal to control an operation of mobile machine 100 as well as to provide a display, alert, recommendation, or some other indication on an interface or interface mechanism based on the position of mobile machine 100 on worksite 602. The indication can include an audio, visual, or haptic output. For instance, topographic confidence system 330 can automatically control the machine to change operation upon exit from one zone 614 and entrance into another zone 614, such as automatically adjusting the speed of the machine upon exit from zone 614-3 and entrance into zone 614-2. Additionally, topographic confidence system 330 can provide an indication to the operator that the machine has entered a different zone.

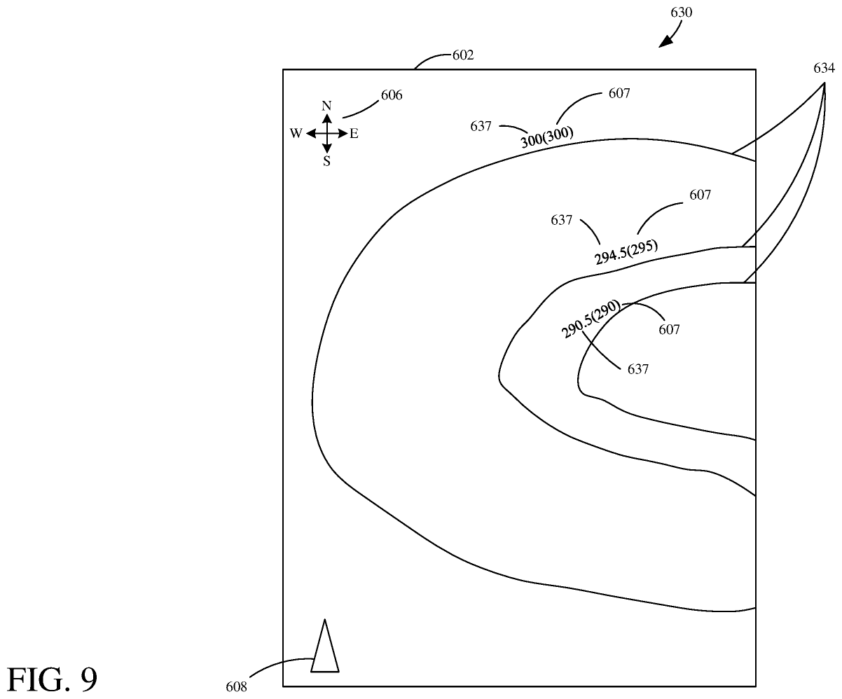

FIG. 9 is one example of a corrected topographic map 630 of a worksite that can be generated by topographic confidence system 330, based on supplemental data relative to worksite 602 or the environment of worksite 602. As described above, in some instances the collected supplemental data will provide an accurate or relatively accurate indication of the topographic characteristics of the worksite such that the actual or a substantial approximation of the actual topographic characteristics of the worksite can be determined by topographic confidence system 330. For instance, a subsequent aerial survey of worksite 602 (performed sometime after the data was collected for the prior topographic map 600) can provide sensor signal(s) (e.g., images) that provide accurate indications of the topographic characteristics of worksite 602. For example, the subsequent aerial survey may have been performed at a time when the surface of worksite 602 was still detectable (e.g., vegetation did not yet obscure detection). In one example, corrected topographic map 630 can be generated and used as a new baseline to replace prior topographic map 600. In another example, and particularly if corrected topographic map 630 is generated at a time close enough to the performance of the operation on worksite 602 (e.g., harvesting, spraying, etc.), it can be used by control system 304 or operator 362 or user 366 to control of mobile machine 100 as well as other components of computing architecture 300.

As shown in FIG. 9, corrected topographic map 630 is similar to prior topographic map 600. Corrected topographic map 630 can include topographic representations 637 which indicate the corrected elevation of the surface of worksite 602 relative to a reference level (e.g. sea level) and can also include corrected contour lines 634. In the example shown, corrected topographic map 630 can include topographic representations 607 which indicate the elevation of the surface of worksite 602 relative to a reference level as indicated by the prior topographic map 600. As shown in FIG. 9, topographic representations 607 are bracketed, such that the operator or user can differentiate them from the corrected topographic values as represented by topographic representations 637, though this need not be the case. Representations 607 and 637 can be differentiated in any number of ways, such as different colors, different fonts, as well various other stylistic differences. Additionally, the previous contour lines indicated by prior topographic map 600 can also be displayed on corrected topographic map 630 and displayed in any number of ways to differentiate them, such as using dashed lines, different colors, as well as various other stylistic differences. In another example, the previous topographic characteristics, such as the previous topographic characteristics represented by topographic representations 607, need not be displayed. As illustrated in FIG. 9, corrected topographic map 630 shows that worksite 602 experienced a change in topography, such as a washout (or erosion) in higher areas of the field, thus decreasing their elevation, which subsequently caused material build-up in lower areas of the field, thus increasing the elevation in the lower areas of the field.

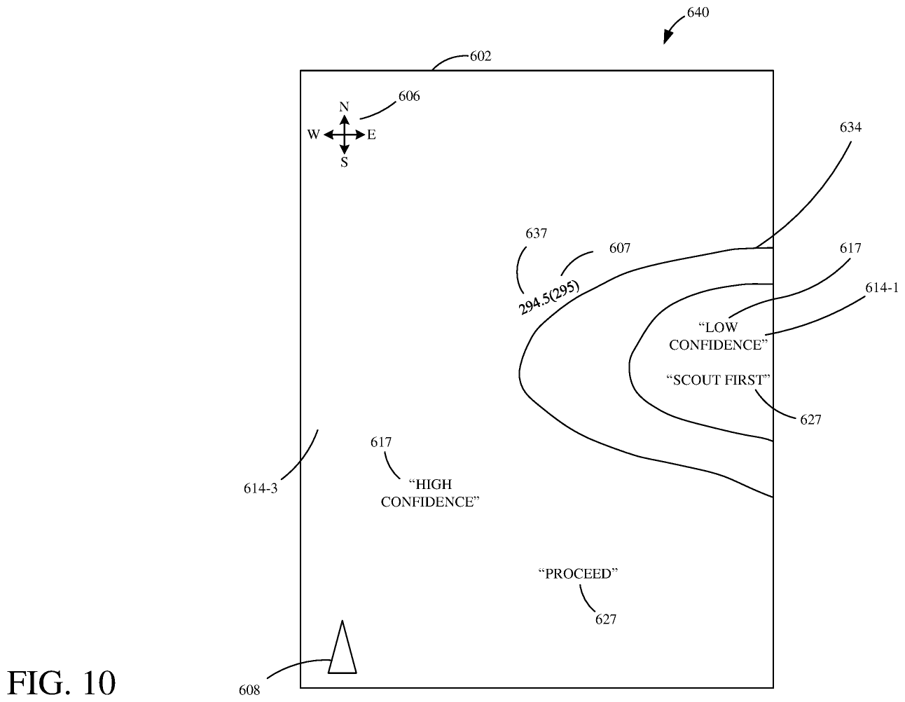

FIG. 10 is one example of a mixed topographic map 640 of a worksite that can be generated by topographic confidence system 330, based on a prior topographic map, such as map 600 and supplemental data relative to worksite 602 or the environment of worksite 602. In some examples, supplemental data can, for at least some areas of the worksite, provide indications of topographic characteristics of worksite 602 that are of a sufficient level of certainty or accuracy such that corrected topographic characteristics can be generated, while some of the supplemental data can, for other areas of the worksite, be used to determine a confidence level in the topographic characteristics as indicated by the prior topographic map. For instance, in some areas of worksite 602, a surface of worksite 602 may be detectable such that the elevation of the surface relative to a reference (e.g., sea level) can be determined, while for other areas, the surface of the worksite may not be detectable. For example, vegetation (as well as other obscurants) may prevent detection in some areas, while not preventing detection in other areas.

In such examples, a mixed topographic map 640 can be generated that includes both representations of corrected topographic characteristics (as indicated by corrected contour lines 634 and corrected topographic representations 637) as well as representations of topographic confidence levels (as represented by confidence zones 614 and confidence level representations 617 and 627). In this way, the operator or user can be provided with a map the indicates, for areas of the field where the topographic characteristics are known to a certain level of accuracy or certainty (which can be based on a threshold as described above), the corrected topographic characteristics. For areas of the field where the topographic characteristics are not known to a certain level of accuracy or certainty map 640 can show the confidence level in the topographic characteristics indicated by the prior topographic map.

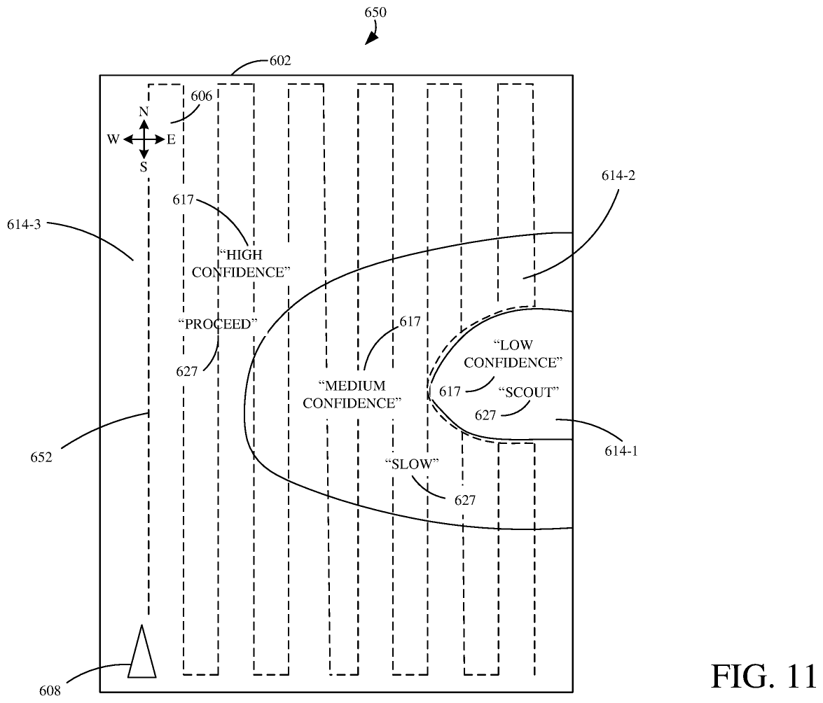

FIG. 11 is one example of a topographic confidence map 650 that can be generated by topographic confidence system 330, based on a prior topographic map, such as map 600 and supplemental data relative to worksite 602 or the environment of worksite 602. As illustrated, topographic confidence map 650 also includes an indication of a route 652 generated by topographic confidence system 330 for a machine (e.g., mobile machine 100) to travel along. Route 652 can be used by control system 304 to automatically control the operation of mobile machine 100 as it travels across worksite 602. For instance, route 652 can be used by control system 304 to generate an action signal to control one or more controllable subsystems 302 of mobile machine 100, such as steering subsystem 316 to control a heading of mobile machine 100.

Additionally, the control of mobile machine 100 can be varied as it operates across worksite 602, based on its position within or proximity to confidence zones 614. For example, in confidence zone 614-3, mobile machine 100 can be controlled based on the topographic characteristics indicated by a prior topographic map, such as map 600, because the topographic confidence level representation 617 is “high” and the advisory representation 627 is “proceed”. Whereas, in zone 614-2, mobile machine 100 can be controlled to adjust speed (e.g., travel slower) because the topographic confidence level representation 617 is “medium” and the advisory representation 627 is “slow”. As can further be seen, route 652 can direct mobile machine 100 to travel around the perimeter, or the edge of, but avoid travel into, zone 614-1 as the topographic confidence level representation 617 is “low” and the advisory representation 627 is “scout. It should also be noted that route 652 can be generated and displayed to an operator or a user, while the operation of the machine (e.g., the heading) is still controlled by the operator or user. In other examples, route 652 may be used directly by a mobile machine operating in semi-autonomous or autonomous modes. Indicator 608 can provide an indication of the position of the machine, and, in the case of operator or user control, can provide an indication of deviation from the recommended travel path (such as a line showing where the machine has actually traveled).

It will noted that the various maps shown in FIGS. 6-11 do not comprise an exhaustive list and that topographic confidence system 330 can generate any number of maps that indicated or other display any number of characteristics, conditions, and or items on or relative to a worksite. It will also be understood that any and all of the maps described above in FIGS. 6-11 can comprise map layers that can be generated by topographic confidence system 330 and can be displayed over other map layers (e.g., as an overlay) and/or individually selectable or toggleable by an operator or user, such as by an input on an actuatable input mechanism on a display screen (e.g., touch screen) on an interface mechanism. For instance, operator 362 of mobile machine 100 may desire to switch between a display of the prior topographic map 600, the topographic confidence map 610, and the topographic confidence map 620 during operation. In this way, operator 362 can be provided with an indication of what the last known topographic characteristics were (e.g., via map 600), what the topographic confidence level across the worksite is (e.g., via map 610), and what the advised operation of mobile machine 100 is across the worksite (e.g., via map 620).

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

It will also be that the various topographic confidence outputs can be output to the cloud.

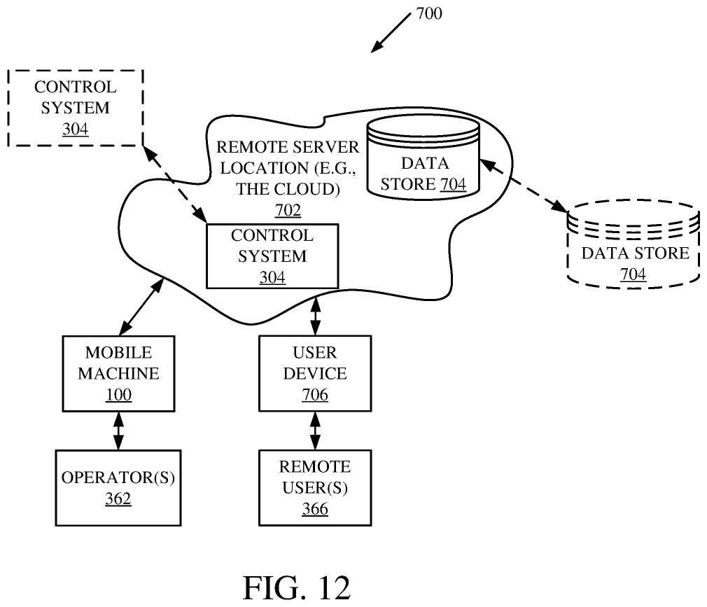

FIG. 12 is a block diagram of a remote server architecture, which shows that components of computing architecture 300 can communicate with elements in a remote server architecture, or that components of computing architecture 300 can be located at a remote server location and can be accessed at the remote server location by other components of computing architecture 300. In an example embodiment, remote server architecture 700 can provide computation, software, data access, and storage services that do not require end-user knowledge of the physical location or configuration of the system that delivers the services. In various embodiments, remote servers can deliver the services over a wide area network, such as the internet, using appropriate protocols. For instance, remote servers can deliver applications over a wide area network and they can be accessed through a web browser or any other computing component. Software or components shown in FIG. 3 as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, they can be provided from a conventional server, or they can be installed on client devices directly, or in other ways.

In the embodiment shown in FIG. 12, some items are similar to those shown in FIG. 3 and they are similarly numbered. FIG. 12 specifically shows that control system 304 can be located at a remote server location 702. Therefore, mobile machine 100, operator(s) 362, and/or remote user(s) 366 access those systems through remote server location 702.

FIG. 12 also depicts another embodiment of a remote server architecture. FIG. 12 shows that it is also contemplated that some elements of FIG. 3 are disposed at remote server location 702 while others are not. By way of example, data store 704 or control system 304 can be disposed at a location separate from location 702, and accessed through the remote server at location 702. Regardless of where they are located, they can be accessed directly by mobile machine 100 and/or operator(s) 362, as well as one or more remote users 366 (via user device 706), through a network (either a wide area network or a local area network), they can be hosted at a remote site by a service, or they can be provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. In such an embodiment, where cell coverage is poor or nonexistent, another mobile machine (such as a fuel truck) can have an automated information collection system. As the mobile machine comes close to the fuel truck for fueling, the system automatically collects the information from the mobile machine using any type of ad-hoc wireless connection. The collected information can then be forwarded to the main network as the fuel truck reaches a location where there is cellular coverage (or other wireless coverage). For instance, the fuel truck may enter a covered location when traveling to fuel other machines or when at a main fuel storage location. All of these architectures are contemplated herein. Further, the information can be stored on the mobile machine until the mobile machine enters a covered location. The harvester, itself, can then send the information to the main network.

It will also be noted that the elements of FIG. 3, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

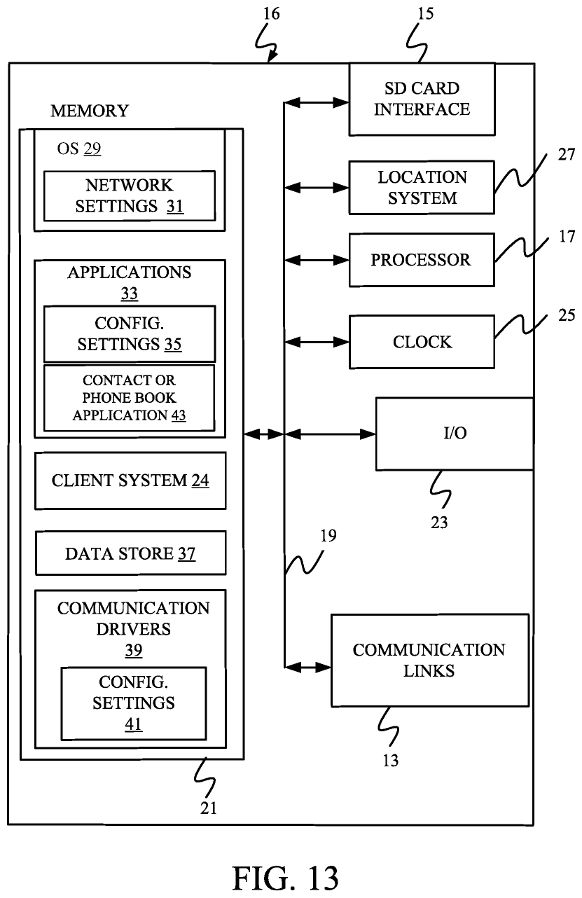

FIG. 13 is a simplified block diagram of one illustrative embodiment of a handheld or mobile computing device that can be used as a user's or client's hand held device 16, in which the present system (or parts of it) can be deployed. For instance, a mobile device can be deployed in the operator compartment of harvester 100 for use in generating, processing, or displaying the stool width and position data. FIGS. 13-15 are examples of handheld or mobile devices.

FIG. 13 provides a general block diagram of the components of a client device 16 that can run some components shown in FIG. 3, that interacts with them, or both. In the device 16, a communications link 13 is provided that allows the handheld device to communicate with other computing devices and under some embodiments provides a channel for receiving information automatically, such as by scanning. Examples of communications link 13 include allowing communication though one or more communication protocols, such as wireless services used to provide cellular access to a network, as well as protocols that provide local wireless connections to networks.

Under other embodiments, applications can be received on a removable Secure Digital (SD) card that is connected to an interface 15. Interface 15 and communication links 13 communicate with a processor 17 (which can also embody processor 108 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

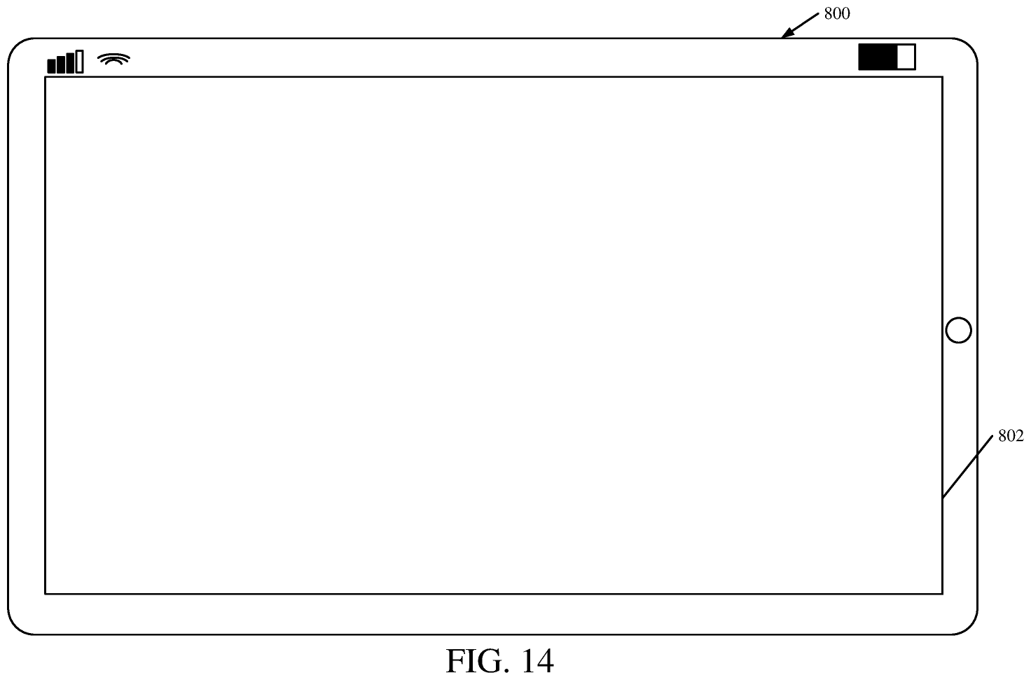

FIG. 14 shows one embodiment in which device 16 is a tablet computer 800. In FIG. 14, computer 800 is shown with user interface display screen 802. Screen 802 can be a touch screen or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 800 can also illustratively receive voice inputs as well.

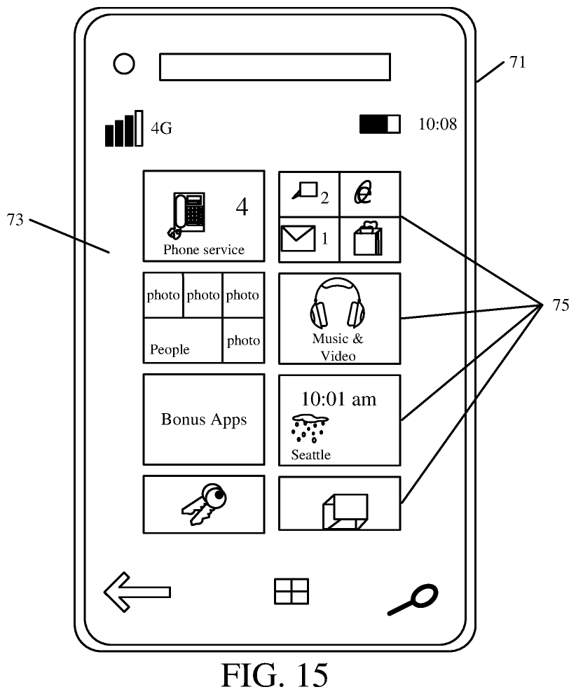

FIG. 15 is similar to FIG. 14 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

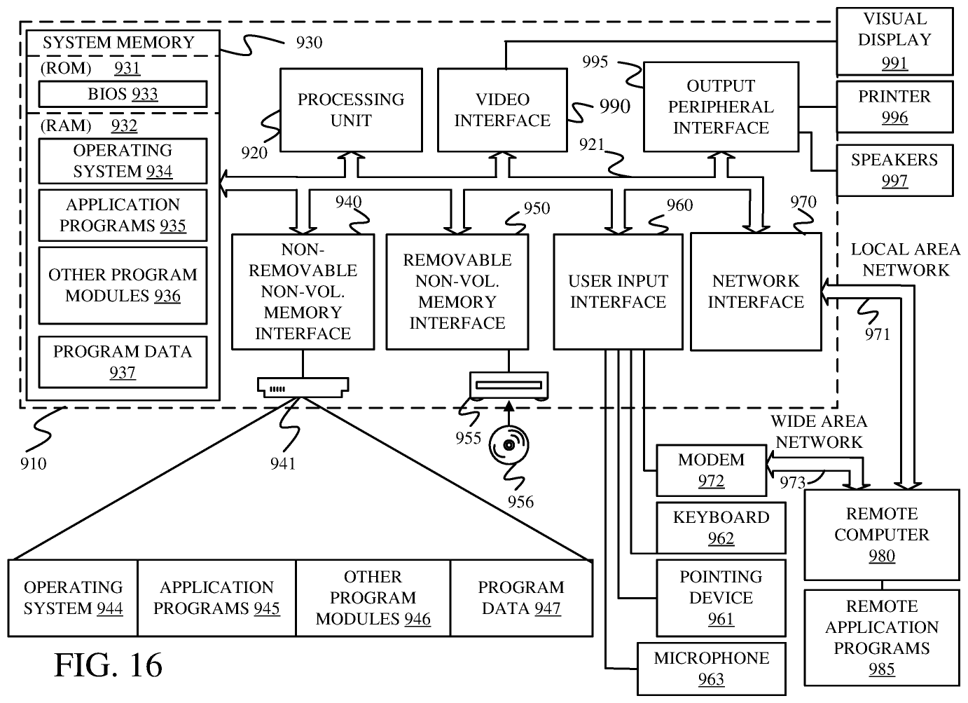

FIG. 16 is one embodiment of a computing environment in which elements of FIG. 3, or parts of it, (for example) can be deployed. With reference to FIG. 16, an exemplary system for implementing some embodiments includes a general-purpose computing device in the form of a computer 910. Components of computer 910 may include, but are not limited to, a processing unit 920 (which can comprise processor(s) 312, 374, and/or 384), a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. Memory and programs described with respect to FIG. 3 can be deployed in corresponding portions of FIG. 16.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 16 illustrates operating system 934, application programs 935, other program modules 936, and program data 937.

The computer 910 may also include other removable/non-removable volatile/nonvolatile computer storage media. By way of example only, FIG. 16 illustrates a hard disk drive 941 that reads from or writes to non-removable, nonvolatile magnetic media, a magnetic disk drive 951, nonvolatile magnetic disk 952, an optical disk drive 955, and nonvolatile optical disk 956. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 16, provide storage of computer readable instructions, data structures, program modules and other data for the computer 910. In FIG. 16, for example, hard disk drive 941 is illustrated as storing operating system 944, application programs 945, other program modules 946, and program data 947. Note that these components can either be the same as or different from operating system 934, application programs 935, other program modules 936, and program data 937.

A user may enter commands and information into the computer 910 through input devices such as a keyboard 962, a microphone 963, and a pointing device 961, such as a mouse, trackball or touch pad. Other input devices (not shown) may include a joystick, game pad, satellite dish, scanner, or the like. These and other input devices are often connected to the processing unit 920 through a user input interface 960 that is coupled to the system bus, but may be connected by other interface and bus structures. A visual display 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 is operated in a networked environment using logical connections (such as a local area network—LAN, or wide area network WAN) to one or more remote computers, such as a remote computer 980.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. In a networked environment, program modules may be stored in a remote memory storage device. FIG. 16 illustrates, for example, that remote application programs 985 can reside on remote computer 980.

It should also be noted that the different embodiments described herein can be combined in different ways. That is, parts of one or more embodiments can be combined with parts of one or more other embodiments. All of this is contemplated herein.

Example 1 is a method of controlling a mobile agricultural machine, comprising:

receiving a topographic map of a worksite indicative of topographic characteristics of a worksite, wherein the topographic characteristics are based on data collected at a first time;

receiving supplemental data indicative of characteristics relative to the worksite, the supplemental data collected after the first time;

generating a topographic confidence output indicative of a confidence level in the topographic characteristics of the worksite as indicated by the topographic map, based on the topographic map and the supplemental data; and

generating an action signal to control an action based on the topographic confidence output.

Example 2 is the method of any or all previous examples, wherein generating the confidence output further comprises:

determining the confidence level, wherein the confidence level is indicative of a likelihood that the topographic characteristics of the worksite, as indicated by the topographic map, have changed; and

generating a representation of the confidence level.

Example 3 is the method of any or all previous examples, wherein generating the confidence output further comprises:

generating a map of the worksite that includes an indication of the confidence level.

Example 4 the method of any or all previous examples, wherein generating the confidence output comprises:

determining a plurality of confidence levels, wherein each one of the plurality of confidence levels is indicative of a likelihood that the topographic characteristics of a corresponding one of a plurality of geographic locations within the worksite have changed.

Example 5 is the method of any or all previous examples, and further comprising:

determining a plurality of confidence zones, each one of the confidence zones corresponding to a respective one of the plurality of confidence levels, wherein an operation of the mobile agricultural machine is based on a presence of the mobile agricultural machine in one of the plurality of confidence zones.

Example 6 is the method of any or all previous examples, wherein generating an action signal to control an action comprises:

controlling a vehicle to collect additional data corresponding to the worksite.

Example 7 is the method of any or all previous examples, wherein generating an action signal to control an action comprises:

controlling an actuator of the mobile agricultural machine to drive movement of a component of the mobile agricultural machine to change a position of the component relative to a surface of the worksite.

Example 8 is the method of any or all previous examples, wherein generating an action signal to control an action comprises:

controlling a propulsion subsystem of the mobile agricultural machine to adjust a speed at which the mobile agricultural machine travels over the worksite.

Example 9 is the method of any or all previous examples, wherein generating an action signal to control an action comprises:

controlling a steering subsystem of the mobile agricultural machine to adjust a heading of the mobile agricultural machine as it travels over the worksite.

Example 10 is the method of any or all previous examples, wherein generating an action signal to control an action comprises:

controlling an interface mechanism communicably coupled to the mobile agricultural machine to provide an indication of the topographic confidence output.

Example 11 is a mobile agricultural machine comprising:

a control system comprising:

a topographic confidence system configured to:

receive a topographic map of a worksite that indicates topographic characteristics of the worksite, wherein the topographic characteristics are based on data collected at a first time;

receive supplemental data indicative of characteristics relative to the worksite, the supplemental data collected after the first time; and

generate a topographic confidence output indicative of a confidence level in the topographic characteristics of the worksite as indicated by the topographic map, based on the topographic map and the supplemental data; and

an action signal generator configured to generate an action signal based on the topographic confidence output.

Example 12 is the mobile agricultural machine of any or all previous examples, wherein the topographic confidence system further comprises:

a terrain change detector that determines a likelihood that the topographic characteristics of the worksite, as indicated by the topographic map, have changed based on the supplemental data; and

a topographic confidence analyzer that determines the topographic confidence level based on the likelihood that the topographic characteristics of the worksite, as indicated by the topographic map, have changed.

Example 13 is the mobile agricultural machine of any or all previous examples, wherein the topographic confidence output includes a representation of the topographic confidence level.

Example 14 is the mobile agricultural machine of any or all previous examples, wherein the topographic confidence system further comprises:

a map generator that generates a map of the worksite that includes an indication of the topographic confidence level.

Example 15 is the mobile agricultural machine of any or all previous examples, wherein the action signal is provided to an actuator of the mobile agricultural machine to drive movement of a component of the mobile agricultural machine to change a position of the component relative to a surface of the worksite.

Example 16 is the mobile agricultural machine of any or all previous examples, wherein the action signal is provided to a propulsion subsystem of the mobile agricultural machine to adjust a speed at which the mobile agricultural machine travels over the worksite.

Example 17 is the mobile agricultural machine of any or all previous examples, wherein the action signal is provided to a steering subsystem of the mobile agricultural machine to adjust a heading of the mobile agricultural machine as it travels over the worksite.

Example 18 is the mobile agricultural machine of any or all previous examples, wherein the action signal is provided to an interface mechanism communicably coupled to the mobile agricultural machine to generate an interface display indicative of the topographic confidence output.

Example 19 is the mobile agricultural machine of any or all previous examples, wherein the action signal is provided to an interface mechanism to provide an indication that directs a human to collect additional data corresponding to the worksite.

Example 20 is a method of controlling a mobile agricultural machine comprising:

receiving a topographic map of a worksite indicative of topographic characteristics of a worksite, wherein the topographic characteristics are based on data collected at a first time;

receiving supplemental data indicative of characteristics relative to the worksite, the supplemental data collected after the first time;

determining topographic confidence levels indicative of a likelihood that the topographic characteristics of the worksite, as indicated by the topographic map, have changed, based on the supplemental data;

generating a topographic confidence map of the worksite that indicates the topographic confidence levels at a plurality of geographic locations within the worksite;

generating an action signal to control an action of the mobile agricultural machine based on the presence of the mobile agricultural machine within one of the plurality of geographic locations indicated on the topographic confidence map.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of controlling a mobile agricultural machine, comprising:
receiving a topographic map of a worksite indicative of topographic characteristics of a worksite, wherein the topographic characteristics are based on data collected at a first time;
receiving supplemental data indicative of characteristics relative to the worksite, the supplemental data collected after the first time;
generating a topographic confidence output indicative of a confidence level in the topographic characteristics of the worksite as indicated by the topographic map, based on the topographic map and the supplemental data; and
generating an action signal to control an action based on the topographic confidence output.

2. The method of claim 1, wherein generating the confidence output further comprises:
determining the confidence level, wherein the confidence level is indicative of a likelihood that the topographic characteristics of the worksite, as indicated by the topographic map, have changed; and
generating a representation of the confidence level.

3. The method of claim 1, wherein generating the confidence output further comprises:
generating a map of the worksite that includes an indication of the confidence level.

4. The method of claim 1, wherein generating the confidence output comprises:
determining a plurality of confidence levels, wherein each one of the plurality of confidence levels is indicative of a likelihood that the topographic characteristics of a corresponding one of a plurality of geographic locations within the worksite have changed.

5. The method of claim 4, and further comprising:
determining a plurality of confidence zones, each one of the confidence zones corresponding to a respective one of the plurality of confidence levels, wherein an operation of the mobile agricultural machine is based on a presence of the mobile agricultural machine in one of the plurality of confidence zones.

6. The method of claim 1, wherein generating an action signal to control an action comprises:
controlling a vehicle to collect additional data corresponding to the worksite.

7. The method of claim 1, wherein generating an action signal to control an action comprises:
controlling an actuator of the mobile agricultural machine to drive movement of a component of the mobile agricultural machine to change a position of the component relative to a surface of the worksite.

8. The method of claim 1, wherein generating an action signal to control an action comprises:
controlling a propulsion subsystem of the mobile agricultural machine to adjust a speed at which the mobile agricultural machine travels over the worksite.

9. The method of claim 1, wherein generating an action signal to control an action comprises:
controlling a steering subsystem of the mobile agricultural machine to adjust a heading of the mobile agricultural machine as it travels over the worksite.

10. The method of claim 1, wherein generating an action signal to control an action comprises:
controlling an interface mechanism communicably coupled to the mobile agricultural machine to provide an indication of the topographic confidence output.

11. A mobile agricultural machine comprising:
a control system comprising:
a topographic confidence system configured to:
receive a topographic map of a worksite that indicates topographic characteristics of the worksite, wherein the topographic characteristics are based on data collected at a first time;
receive supplemental data indicative of characteristics relative to the worksite, the supplemental data collected after the first time; and
generate a topographic confidence output indicative of a confidence level in the topographic characteristics of the worksite as indicated by the topographic map, based on the topographic map and the supplemental data; and
an action signal generator configured to generate an action signal based on the topographic confidence output.

12. The mobile agricultural machine of claim 11, wherein the topographic confidence system further comprises:
a terrain change detector that determines a likelihood that the topographic characteristics of the worksite, as indicated by the topographic map, have changed based on the supplemental data; and
a topographic confidence analyzer that determines the topographic confidence level based on the likelihood that the topographic characteristics of the worksite, as indicated by the topographic map, have changed.

13. The mobile agricultural machine of claim 11, wherein the topographic confidence output includes a representation of the topographic confidence level.

14. The mobile agricultural machine of claim 11, wherein the topographic confidence system further comprises:
a map generator that generates a map of the worksite that includes an indication of the topographic confidence level.

15. The mobile agricultural machine of claim 11, wherein the action signal is provided to an actuator of the mobile agricultural machine to drive movement of a component of the mobile agricultural machine to change a position of the component relative to a surface of the worksite.

16. The mobile agricultural machine of claim 11, wherein the action signal is provided to a propulsion subsystem of the mobile agricultural machine to adjust a speed at which the mobile agricultural machine travels over the worksite.

17. The mobile agricultural machine of claim 11, wherein the action signal is provided to a steering subsystem of the mobile agricultural machine to adjust a heading of the mobile agricultural machine as it travels over the worksite.

18. The mobile agricultural machine of claim 11, wherein the action signal is provided to an interface mechanism communicably coupled to the mobile agricultural machine to generate an interface display indicative of the topographic confidence output.

19. The mobile agricultural machine of claim 11, wherein the action signal is provided to an interface mechanism to provide an indication that directs a human to collect additional data corresponding to the worksite.

20. A method of controlling a mobile agricultural machine comprising:
receiving a topographic map of a worksite indicative of topographic characteristics of a worksite, wherein the topographic characteristics are based on data collected at a first time;
receiving supplemental data indicative of characteristics relative to the worksite, the supplemental data collected after the first time;
determining topographic confidence levels indicative of a likelihood that the topographic characteristics of the worksite, as indicated by the topographic map, have changed, based on the supplemental data;
generating a topographic confidence map of the worksite that indicates the topographic confidence levels at a plurality of geographic locations within the worksite;
generating an action signal to control an action of the mobile agricultural machine based on the presence of the mobile agricultural machine within one of the plurality of geographic locations indicated on the topographic confidence map.
